(19) United States
(12) Patent Application Publication
(10) Pub. No.: US 2018/0218053 A1
(43) Pub. Date: Aug. 2, 2018

(54) Big Data Analytical Platform Tools And Methods Of Use

(71) Applicant: Anvizent Analytics Pvt., LTD, Bengaluru (IN)

(72) Inventor: Rajani Koneru, Alpharetta, GA (US)

(73) Assignee: Anvizent Analytics Pvt., LTD., Bengaluru (IN)

(21) Appl. No.: 15/884,784

(22) Filed: Jan. 31, 2018

Related U.S. Application Data
(60) Provisional application No. 62/453,069, filed on Feb. 1, 2017.
(60) Provisional application No. 62/623,704, filed on Jan. 30, 2018.

(51) Int. Cl. G06F 17/30; G06F 3/0482

(52) U.S. Cl. CPC G06F 17/30563; G06F 3/0482; G06F 17/3056

(57) ABSTRACT

Methods and systems for extraction, transformation, and loading of source data into an integrated extract-transform-load (ETL) data warehouse analytical platform to map source data from at least one data source column as mapped source data to at least one Input Layout (IL) column of a selected IL table of a plurality of IL tables associated with a Data Layout (DL) table of a plurality of DL tables associated with a named standard package or to a custom target table associated with a named custom package to permit a real-time display on a graphical user interface (GUI) of one or more key performance indicators associated with each DL table.

### CROSS-REFERENCE TO RELATED APPLICATIONS

The present specification claims priority to U.S. Provisional Patent Application No. 62/453,069, filed Feb. 1, 2017, and U.S. Provisional Patent Application No. 62/623,704, filed Jan. 30, 2018, each entitled “BIG DATA ANALYTICAL PLATFORM TOOLS AND METHODS OF USE,” the entirety of each of which is incorporated by reference herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the patent and trademark office patent file or records, but otherwise reserves all copyright rights whatsoever.

### TECHNICAL FIELD

The present specification generally relates to analytical platform tools to provide industry metrics and, more specifically, to big data analytical platform tools to provide and end-to-end solution for industry-wide metrics in strategic industries and methods of use of such tools.

### BACKGROUND

Conventional big data analytical tools focus on separate aspects of a total solution rather than providing a complete end-to-end solution due to complexities involved in such data analytics. Companies using end line versions of such tools also tend to create and customize their own metrics, leading to an increased cost of time and efficiency in developing code to build such metrics.

Accordingly, as the above steps are disjointed and may result in inefficiencies of use and lost potentially valuable data analytics, a need exists for alternative tools to streamline the process to analyze big data in a singular platform providing an end-to-end solution including standardized metrics for a strategic industries and methods of use of such tools.

### SUMMARY

In one embodiment, a method of extraction, transformation, and loading of source data into an integrated extract-transform-load (ETL) data warehouse analytical platform may include receiving a user selection on a graphical user interface (GUI) of one of a standard package option and a custom package option, mapping source data from at least one data source column as mapped source data to at least one Input Layout (IL) column of a selected IL table of a plurality of pre-defined IL tables associated with a Data Layout (DL) table associated with a named standard package when the standard package option is selected, and mapping source data as mapped source data to a custom target table associated with a named custom package when the custom package option is selected. The method may further include populating the mapped source data with respect to at least one of the DL table and the custom target table, wherein each of the DL table and the custom target table include a plurality of columns respectively defined as one of a dimension and a measure, eliminating source data that is not mapped to the at least one IL column or the at least one column of the custom target table when populating the mapped source data, and displaying on the GUI at least one of a graphical and tabular report based on one or more key performance indicators (KPIs) associated with at least one of the DL table and the custom target table in real-time.

In another embodiment, a system for extraction, transformation, and loading of source data into an integrated extract-transform-load (ETL) data warehouse analytical platform may include one or more processors, one or more memory modules communicatively coupled to the one or more processors, a GUI, and machine readable instructions stored in the one or more memory modules that cause the system to perform at least the following instructions when executed by the one or more processors. The instructions may be to receive a user selection on the GUI of one of a standard package option and a custom package option, map source data from at least one data source column as mapped source data to at least one Input Layout (IL) column of a selected IL table of a plurality of pre-defined IL tables associated with a Data Layout (DL) table associated with a named standard package when the standard package option is selected, and map source data as mapped source data to a custom target table associated with a named custom package when the custom package option is selected. The instructions may further be to populate by the one or more processors the mapped source data with respect to at least one of the DL table and the custom target table, wherein each of the DL table and the custom target table include a plurality of columns respectively defined as one of a dimension and a measure, eliminate by the one or more processors source data that is not mapped to the at least one IL column or the at least one column of the custom target table when populating the mapped source data, and display on the GUI at least one of a graphical and tabular report based on one or more key performance indicators (KPIs) associated with at least one of the DL table and the custom target table in real-time.

In yet another embodiment, a method of extraction, transformation, and loading of source data into an integrated ETL data warehouse analytical platform may include receiving a user selection on a graphical user interface (GUI) of one of a standard package option and a custom package option, mapping source data from at least one data source column as mapped source data to at least one Input Layout (IL) column of a selected IL table of a plurality of IL tables associated with a Data Layout (DL) table associated with a named standard package when the standard package option is selected, mapping source data as mapped source data to a custom target table associated with a named custom package when the custom package option is selected, and populating the mapped source data with respect to at least one of the DL table and the custom target table, wherein each of the DL table and the custom target table include a plurality of columns respectively defined as one of a dimension and a measure. The method may further include opening upon a dashboard developer application to select on a GUI of the dashboard developer application at least one of the DL table and the custom target table as a data set from which to display at least one of a graphical and tabular report, receiving a user selection on the GUI of the dashboard developer application of at least one dimension and at least one measure from the data set to display as the at least one of a graphical and tabular report, and displaying in real-time on the GUI of the dashboard developer application the at least one of a graphical and tabular report based on the at least one dimension and the at least one measure representative of one or more key performance indicators (KPIs) associated with at least one of the DL table and the custom target table.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a schematic example of system architecture of an ETL data warehouse system, according to one or more embodiments shown and described herein;

FIG. 2 illustrates a graphical user interface (GUI) screen from which to select from standard or custom package options, according to one or more embodiments shown and described herein;

FIG. 3 illustrates a GUI screen of a screen including details and edit options regarding a selected standard package, according to one or more embodiments shown and described herein;

FIG. 4 illustrates an example DL table structure, according to one or more embodiments shown and described herein;

FIG. 5 illustrates a GUI screen of an example add IL source screen, according to one or more embodiments shown and described herein;

FIG. 6 illustrates a GUI screen of an example flat file upload as a data source to a selected IL table structure, according to one or more embodiments shown and described herein;

FIG. 7 illustrates a GUI screen of an example database upload as a data source to a selected IL table structure, according to one or more embodiments shown and described herein;

FIG. 8 illustrates a GUI screen of an example add IL source screen including a flat file details screen portion, according to one or more embodiments shown and described herein;

FIG. 9 illustrates a GUI screen of an example database connection detail screen in which a database query is mapped as a data source to an IL table structure, according to one or more embodiments shown and described herein;

FIG. 10 illustrates a GUI screen from which to create and name a new custom package, according to one or more embodiments shown and described herein;

FIG. 11 illustrates a GUI screen from which to upload one or more source files to the new custom package of FIG. 10 and set details regarding the source file(s) which are indicated to include a same set of headers, according to one or more embodiments shown and described herein;

FIG. 12 illustrates a GUI screen of an example in which a flat file has been uploaded as a data source to the new custom package of FIG. 10, according to one or more embodiments shown and described herein;

FIG. 13 illustrates a GUI screen of an example of details regarding an existing database as a data source for upload to the new custom package of FIG. 10, according to one or more embodiments shown and described herein;

FIG. 14 illustrates a GUI screen of an example in which a database has been uploaded as a data source to the new custom package of FIG. 10, according to one or more embodiments shown and described herein;

FIG. 15 illustrates a GUI screen of a table creation page during a mapping stage illustrating column headers and information for the uploaded data set for the new custom package of FIG. 10, according to one or more embodiments shown and described herein;

FIG. 16 illustrates a GUI screen of a screen for a process stage to process or schedule processing of underlying data from the one or more data sources into the created table for the new custom package of FIG. 10, according to one or more embodiments shown and described herein;

FIG. 17 illustrates a GUI screen of an example scheduling or process selection, according to one or more embodiments shown and described herein;

FIG. 18 illustrates a GUI screen indicating one or more source files to upload in an upload stage to the new custom package of FIG. 10 do not include a same set of headers, according to one or more embodiments shown and described herein;

FIG. 19 illustrates a GUI screen of an example screen for an upload stage when joining columns with different headers from at least two data sources, according to one or more embodiments shown and described herein;

FIG. 20 illustrates a GUI screen of an example target table created with the joined sources of FIG. 19 and including table details, according to one or more embodiments shown and described herein;

FIG. 21 illustrates a GUI screen of an example target table creation page in which to define columns as dimensions or measures, according to one or more embodiments shown and described herein;

FIG. 22 illustrates a GUI screen from which to select edit or view options with respect to a created custom package, according to one or more embodiments shown and described herein;

FIG. 23 illustrates a GUI screen of a results stage utilizing a dashboard developer and from which to select a data source such as a database to develop and create a dashboard, according to one or more embodiments shown and described herein;

FIG. 24 illustrates a GUI screen of a table selection window of the results stage from which to select a table from the selected database of FIG. 23, according to one or more embodiments shown and described herein;

FIG. 25 illustrates a GUI screen of a dashboard selection page to create a dashboard based on the table selection of FIG. 24, according to one or more embodiments shown and described herein;

FIG. 26 illustrates a GUI screen of a dashboard creation options screen to set options regarding the dashboard selection of FIG. 25, according to one or more embodiments shown and described herein;

FIG. 27 illustrates a GUI screen of an example of visual reports including charts and filters based on the dashboard creation options selected in FIG. 26, according to one or more embodiments shown and described herein;

FIG. 28 illustrates a GUI screen of another example of visual reports including charts, tabular data, and pivot option data based on the dashboard creation options selected in FIG. 26, according to one or more embodiments shown and described herein;

FIG. 29 illustrates a GUI screen of another example of visual reports including charts, tabular data, and a pivot chart based on the dashboard creation options selected in FIG. 26, according to one or more embodiments shown and described herein;

FIG. 30 schematically illustrates a system for implementing computer and software based methods to utilize the tool(s) of FIGS. 1-29 for extraction, transformation, and loading of source data into an integrated ETL data warehouse analytical platform, such as through a plurality of IL table structures, each IL table structure selectable as a component of a plurality of DL table structures, or as a custom derived table, permitting a real-time display on a GUI of one or more key performance indicators associated with each DL table structure, according to one or more embodiments shown and described herein;

FIG. 31 illustrates a flow chart of a process for utilizing the system of FIG. 30 to extract, transform, and load source data into an integrated ETL data warehouse analytical platform as a plurality of IL table structures;

FIG. 32 illustrates another flow chart of a process for utilizing the system of FIG. 30 to extract, transform, and load source data into an integrated ETL data warehouse analytical platform as a plurality of IL table structures;

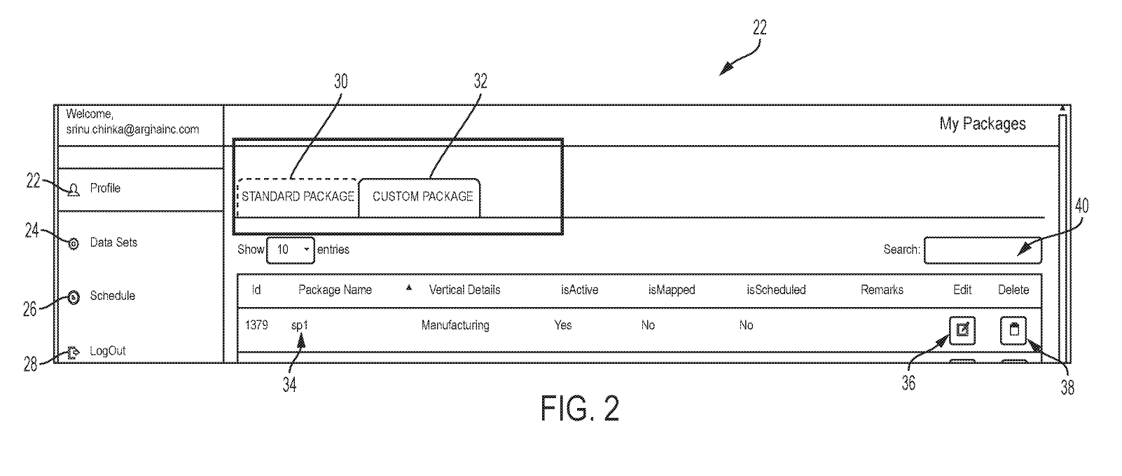

Appendix A contains examples of code associated with each of the GUI screens of FIGS. 2-29 above; and

Appendix B contains examples of code associated with the GUI screens of the figures of U.S. Provisional Patent Application No. 62/623,704, filed Jan. 30, 2018, the entirety of which is incorporated by reference above.

### DETAILED DESCRIPTION

Referring generally to the figures, embodiments of the present disclosure are directed to a big data analytics platform tool to provide a method for end-to-end data integration and analytics for one or more strategic industries. Such industries may be, for example, a manufacturing industry, a quick service restaurant industry, or the like. Such industries may have need for a majority of similar key performance indicator metrics, with a smaller amount of customizable metric needs. The tool describes herein provides an end-to-end solution to integrate data sources from such industries into a single platform to provide standardized yet customizable key performance indicator data as easy to use visual and other dashboard reports that are more efficient to process and output. The tool utilizes a mapping feature to integrate data from one or more sources into a plurality of Input Layout (“IL”) tables, which IL tables are utilized in a data warehouse structure to build a plurality of Data Layout (“DL”) tables accessible by a Dashboard to build key performance indicator charts in a real-time manner that are specific to clientele data.

The platform tool may employ one or more databases, such as a database that may be, for example, a structured query language (SQL) database or a like database that may be associated with a relational database management system (RDBMS) and/or an object-relational database management system (ORDBMS). The database may be any other large-scale storage and retrieval mechanism whether a SQL, SQL including, or a non-SQL database. For example, the database may utilize one or more big data storage computer architecture solutions. Such big data storage solutions may support large data sets in a hyperscale and/or distributed computing environment, which may, for example, include a variety of servers utilizing direct-attached storage (DAS). Such database environments may include Hadoop, NoSQL, and Cassandra that may be usable as analytics engines. Thus, while SQL is referenced herein as an example database that is used with the tool described herein, it is understood that any other such type of database capable of support large amounts of database, whether currently available or yet-to-be developed, and as understood to those of ordinary skill in the art, may be utilized with the tool described herein as well.

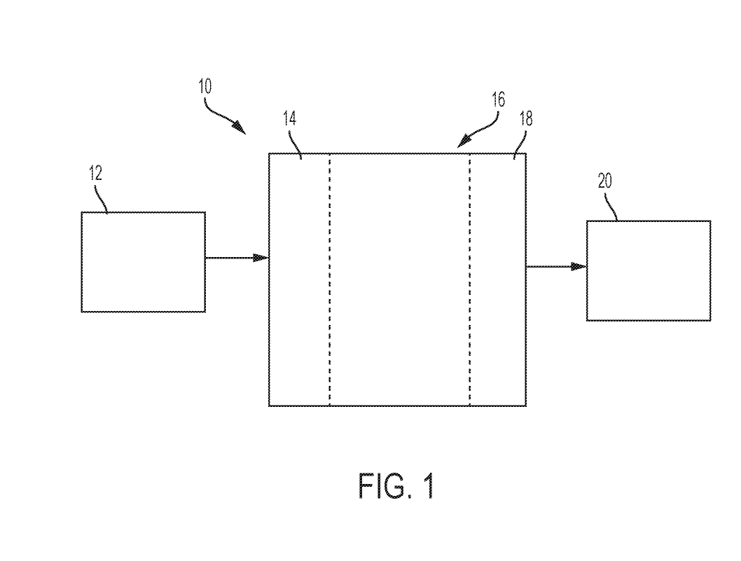

Referring to FIG. 1, a system 10 includes a source database 12, an extract-transform-load (ETL) data warehouse tool 16, and a visualization engine 20. The ETL data warehouse tool 16 includes an Input Layout (“IL”) module 14 in communication with the source database 12 and a Data Layout (“DL”) module 18 in communication with the visualization engine 20.

The source database 12 may include data from one or more sources, such as a relational database, enterprise resource planning (“ERP”) data, customer relationship management (“CRM”) data, purchased data, legacy data, or the like. In embodiments, such ERP data or other source data may be sourced from programs such as ORACLE, EPICOR, SAGE, SAP, SALESFORCE, JD EDWARDS, MICROSOFT DYNAMICS ERP, INFOR, or the like. Such data may also be sourced from companies or entities operating through one or more open source software-based and cloud-based architectures. An SQL Query may be pre-built and configurable as a ERP data extraction package. Other custom data may include inputs such as thresholds, targets, currency conversions, custom formulas, other customer specific information, and the like. Through the ETL data warehouse 16 and the IL module 14, the source data is extracted, transformed, and loaded as mapped data, as described in greater detail further below, into a plurality of IL table structures. One or more data filters may be applied, as described further below, as well as an option to schedule through a Scheduler tool when to query the source data to update the IL table structures. Further, key performance indicator (“KPI”) calculations may be pre-set and refreshed to run upon the IL table structures.

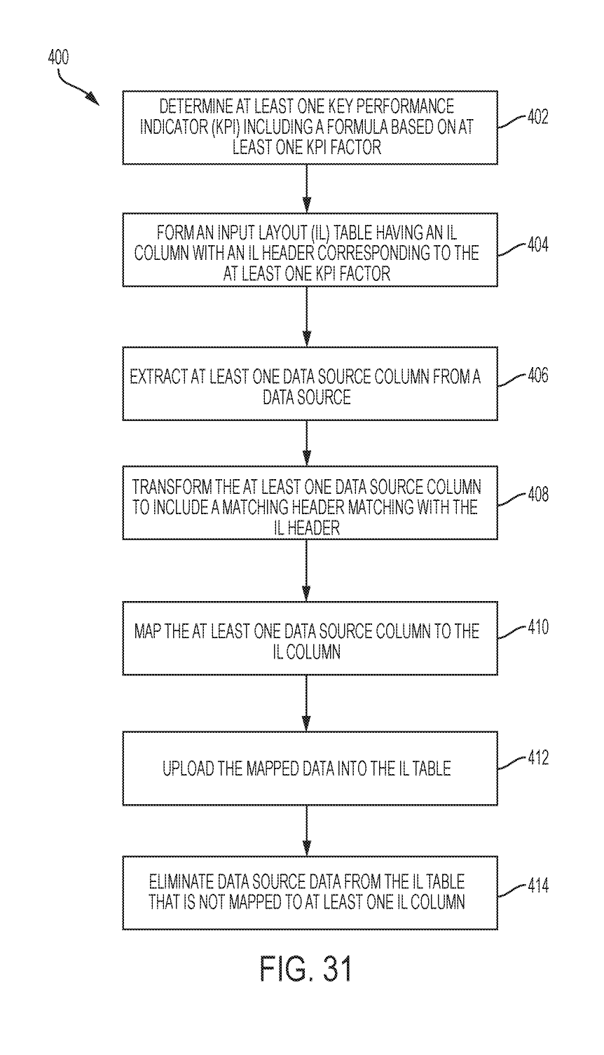

Referring to FIG. 31, a non-limiting example of a flow chart is illustrated for the process 400 of utilizing the system described herein to extract, transform, and load source data into an integrated ETL data warehouse analytical platform as a plurality of IL table structures. In step 402, at least one KPI that includes a formula at least partially based on at least on KPI factor is determined and input in to the system. For example, in step 404, an IL table structure having an IL column is formed, which IL column includes an IL header that corresponds to the at least one KPI factor. Additionally or alternatively, an identifier may be used (i.e., rather than a column header). In step 406, data from at least one data source column is extracted from a data source, as described in greater detail further below. In step 408, the extracted data from the at least one data source column is transformed to include a matching header that matches the IL header (or, for example, to be matched to identifiers that match with the identifiers associates with the IL column). In step 410, the transformed data source column is mapped to the IL column. As will be described in greater detail below, data from more than one data source column may be combined and transformed to be mapped to the IL column. In step 412, the mapped data is uploaded to the IL column of the IL table structure to populate the IL column with the data from the at least one data source column. In step 414 of the process 400, as described in greater detail further below, data source data may be eliminated from the IL table structure that is not mapped to the at least one IL column.

The IL tables structures are selectable to build the DL table structures, from which one or more reports may be built and viewed in real-time upon a Dashboard of a graphical user interface (GUI) through the visualization engine 20. For example, thousands of pre-built KPI' s and Dashboards may be stored in a KPI library in the visualization engine 20 and, based on the plurality of DL table structures, accessible through the DL module 18. The visualization engine 20 may further include business performance management components, such as collaboration and communication tools, push based alerts, and a threshold management system, as described in greater detail below.

A user may sign in to the ETL data warehouse tool 16 to access their custom and specific table structures and reports. For example, the ETL data warehouse tool 16 is used to process user provided data to build quick dashboard including one or more desired, pre-built reports in adaptable views based on the user provided data in real-time. As non-limiting examples, the ETL data warehouse tool 16 takes as input the user provided data that is provided in a form of flat files (such as EXCEL files having a .csv file extension) or database queries or stored procedures as described in greater detail further below. The ETL data warehouse tool 16 processes the user provided data and keeps the data required to create a user dashboard and eliminates data not relevant to creation of the user dashboard, allowing for a quicker and more efficient processing of the user provided data. Thus, only data mapped to the IL table structures upon which the DL table structures are built will be retained by the ETL data warehouse tool 16. The ETL data warehouse tool 16 is responsible for parsing through the total input data and eliminating such portions that are not to be mapped to the IL table structures upon the ETL stage of data input into the ETL data warehouse tool 16. For example, as set forth in step 414 of the process 400, data source data may be eliminated from the IL table structure that is not mapped to the at least one IL column or may be eliminated prior to any such initial mapping between the one or more data source columns and the at least one IL column.

In embodiments, the tool is able to consume application program interfaces (APIs) of separate systems through an abstraction layering such that one or more APIs are consumed in a programmatic manner through a tool interface that makes such calls (i.e., API and/or SQL calls) in an automated sequence based prebuilt analytics ontology that may be associated with, for example, industry standards for a select industry. The tool utilizes the tool interface to automatically make such calls to pull in layers from external data sources that are extracted, transformed, and loaded into the tool as described herein in an optimized, efficient, and speedy manner that does not rely on customizable case-by-case call consumption alone but rather performs a majority of calls automatically and in a pre-set sequence through use of the pre-built analytics of the tool infrastructure. Thus, a broad range of systems may be used as external data sources from which data is extracted, transformed, and loaded in the Input Layout (“IL”) module 14 and Data Layout (“DL”) module 18 of the ETL data warehouse tool 16 through use of an automated sequence of pre-programmed calls across the external data sources.

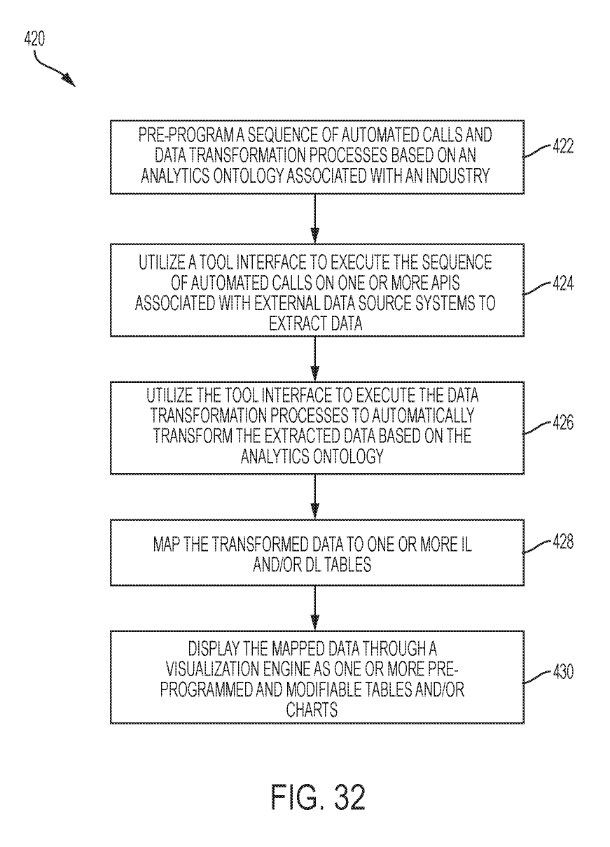

Referring to FIG. 32, another non-limiting example of a flow chart is illustrated for the process 420 of utilizing the system described herein to extract, transform, and load source data into an integrated ETL data warehouse analytical platform as a plurality of IL and/or DL table structures through use of such an automated sequence of pre-programmed calls. In step 422, a sequence of automated calls and data transformation processes based on an analytics ontology associated with an industry are pre-programmed into the tool and may be accessed through the tool interface. For example, in step 424, the tool interface is utilized to execute the sequence of automated calls on one or more APIs associated with external data source systems to extract data. In embodiments, one or more pre-programmed automated API calls and/or SQL calls may be made on external data sources in a programmatic manner through the tool interface. In step 426, the tool interface is utilized to execute the data transformation processes to automatically transform the extracted data based on the analytics ontology. In step 428, the transformed data is automatically mapped to one or more IL and/or DL table structures as described herein. In step 430, the mapped data is displayed through the visualization engine 20 as described herein and in greater detail further below as one or more pre-programmed and modifiable tables and/or charts.

In embodiment, and with reference to the tool interface, a user may sign into a secure account on a log in screen of the ETL data warehouse tool 16. A user profile may show a client id and user name as well as any user associated database names. Screen button options may be presented to the user, such as Profile 22 (to view the user profile, for example), Data Sets 24, Schedule 26, and Logout 28 to permit the user to log off or out of the ETL data warehouse tool 16 application. The Schedule 26 option populates a list of standard and custom packages, from which list a user may view details for each package such as names, current status of scheduling (i.e., pending or done), schedule time (i.e., if already scheduled), and other scheduling information. The Schedule 26 page also allows the user to process data as described in greater detail further below. Selection of the Data Sets 24 button option allows a user to select between Standard Package option 30 and a Custom Package option 32, as illustrated in FIG. 2.

Referring to FIG. 2, two tabs are respectively associated with a Standard Package option 30 and a Custom Package option 32. The Standard Package option 30 may be the default option, which screen opens with the Data Sets 24 button option is selected. A user may add data sets into standard IL table structures if the data sets match with such tables, and the DL table structure will fetch data from a defined one or more IL table structures and contain processed data from which the DL table structure may build one or more dashboards to output reports through the visualization engine 20. If the Custom Package option 32 is selected, a user may create a number of user defined custom derived tables. The tables may be used in a similar manner to the Standard Package option 30 tables to create quick dashboards from which to view one or more reports for display on dashboards on the GUI and through the visualization engine 20.

The Standard Package option 30 screen presents a user with a list of standard packages 34 already created by the user. The list presents the user with an option to edit 36 or delete 38 the existing standard package or to create a new standard package. The delete 38 option may open a popup window when selected to request that the user confirms that this is the desired action. A user may also utilize a search option 40 to search for a desired standard package. Selection of the option to create a new standard package may cause a window to open in which a user gives a name to the new package, which is acceptable if the name does not match any existing package name (or otherwise give an error message indicating the package name already exists). The user may then map data sources with IL table structures for the new package in a manner similar to use of the edit 36 option as described below.

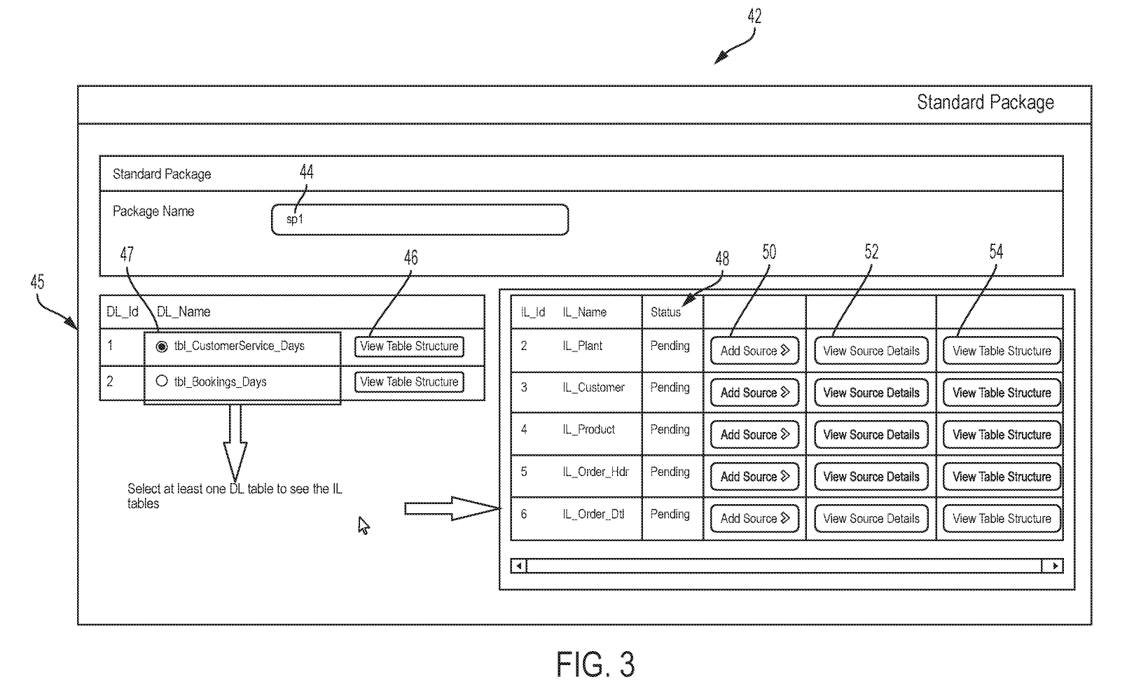

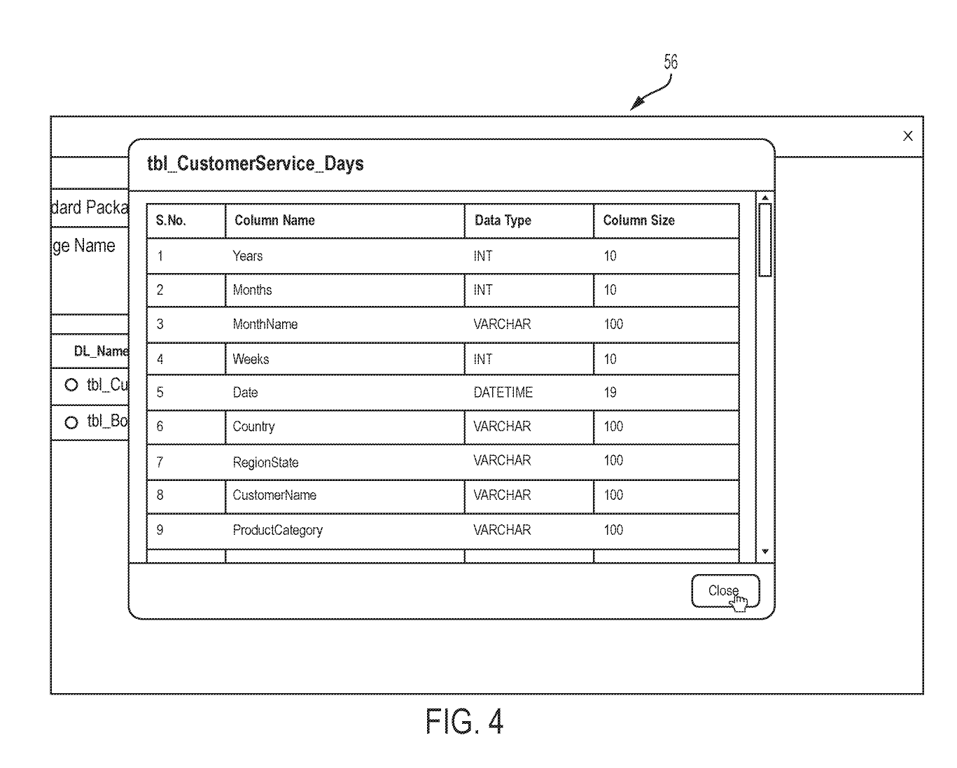

Selection of the edit 36 option to edit a selected standard package may launch a screen 42 as shown in FIG. 3 including the selected package name 44 and a list 45 of DL table structures under the selected standard package. The list 45 of DL table structures may include a DL table structure identification, a DL table structure name, and a View Table Structure 46 option, selection of which allows a user to view the DL table structure details of a particular DL table structure such as column details, data type, and column size of each selected DL table structure. Referring to FIG. 4, a dialog box 56 may be opened in which such details related to a DL table structure may be displayed, and which may be closed to return to the screen 42. For example, as shown in FIG. 4, an example DL table structure may have the name tbl_CustomerService_Days, and may have a plurality of columns with listed names such as Years (of an integer data type “INT”, with a column size of 10 columns), Months (an INT data type, with a column size of 10 columns), MonthName (a text data type referred to as “VARCHAR” in the figures, with a column size of 100 columns), Date (a DATETIME data type, with a column size of 19 columns), CustomerName (a VARCHAR data type, with a column size of 100 columns), and the like.

Referring still to FIG. 3, a radio button 47 may be selected to view which IL table structures as shown in a list 48 are associated with a particular DL table structure. The list 48 may include an IL table structure identification, an IL table structure name, a status of the IL table structure (whether pending or done). A pending status indicates no source data is mapped with a particular IL table structure, and a done status indicates one or more IL table structures are mapped with source data. The list 48 may further include options associated with each IL table structure include Add Source 50, View Source Details 52, and View Table Structure 54. Add Source 50 is an option to add a new source data to the IL table structure. A number of source files that follow the same data/table structure may be added, and the IL table structure may be mapped with at least one source file to change the status of that particular IL table structure from pending to done.

Referring again to FIG. 3, View Source Details 52 is an option to view the details of any source data mapped to the IL table structure. For example, this button may open a dialog box that gives a user details of whether a flat file (such as one with a .csv file extension) or a query (such as a database link) has been uploaded through a done status display, or whether nothing has been uploaded yet through a pending status display. View Table Structure 54 is an option to view details of the IL table structure such as column names, data types, and sizes as described above.

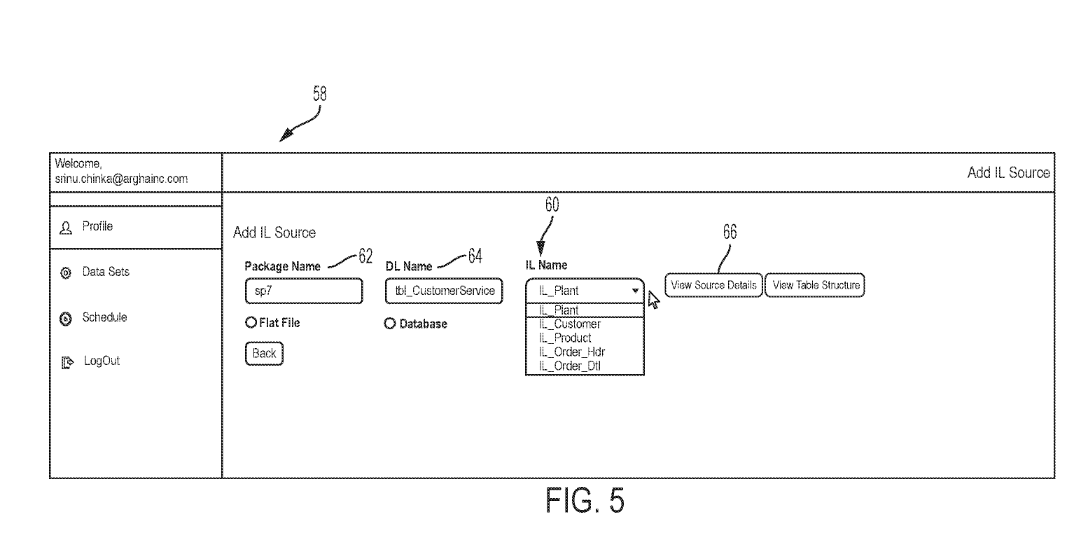

Referring to FIG. 5, through an Add IL Source screen 58, an IL table structure may be selected from a list of names 60 of IL table structures to map to a particular DL table structure. The Add IL Source screen 58 may also include a name 62 of the selected standard package, the DL table structure name 64 of the DL table structure to which to add the selected IL table structure, a View Source Details 66 button, a View Table structure button, a flat file radio button, a database radio button, and a back button.

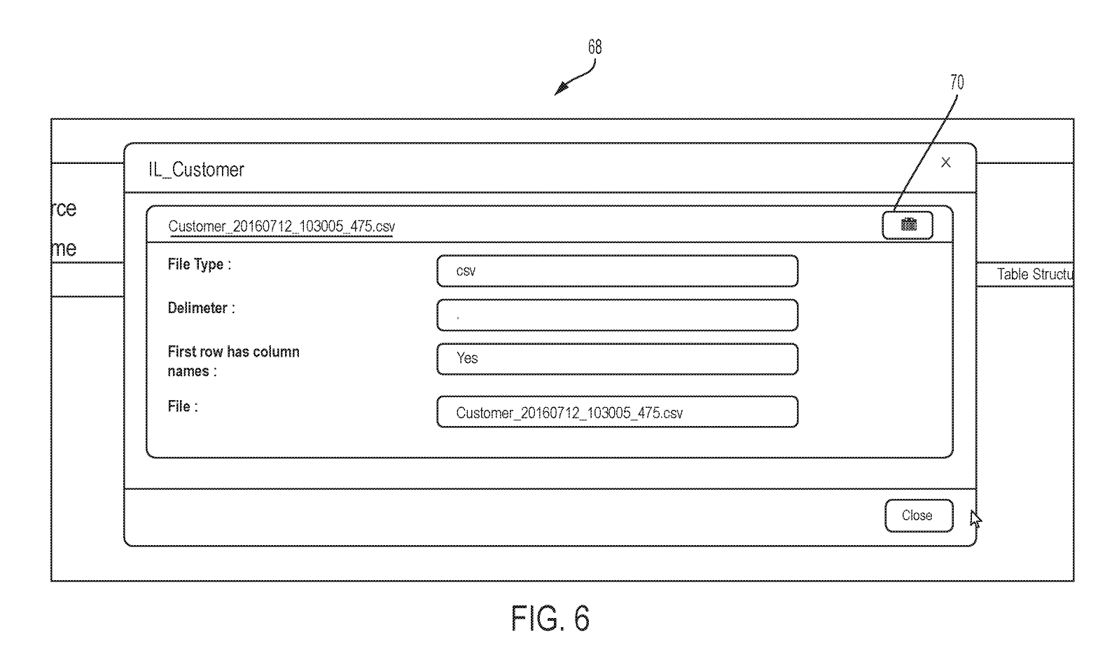

Selection of the View Source Details 66 button may open a dialog box that presents a user with details as to whether a flat file or a query has been uploaded (i.e., a done status) or whether source data has not yet been uploaded (i.e., a pending status) through a message in a pop up video of “No Source File Added,” for example. An example of a dialog box 68 of a flat file upload is shown in FIG. 6 in which an IL table structure named IL_Customer has been selected from the list of names 60. The dialog box 68 shows the file location of the IL_Customer table and indicates that the IL_Customer table is of flat file type (with a .csv file extension and a period delimiter) and has a first row that has column names. The dialog box 68 may also include a delete option 70 to delete an attached source when the status is pending.

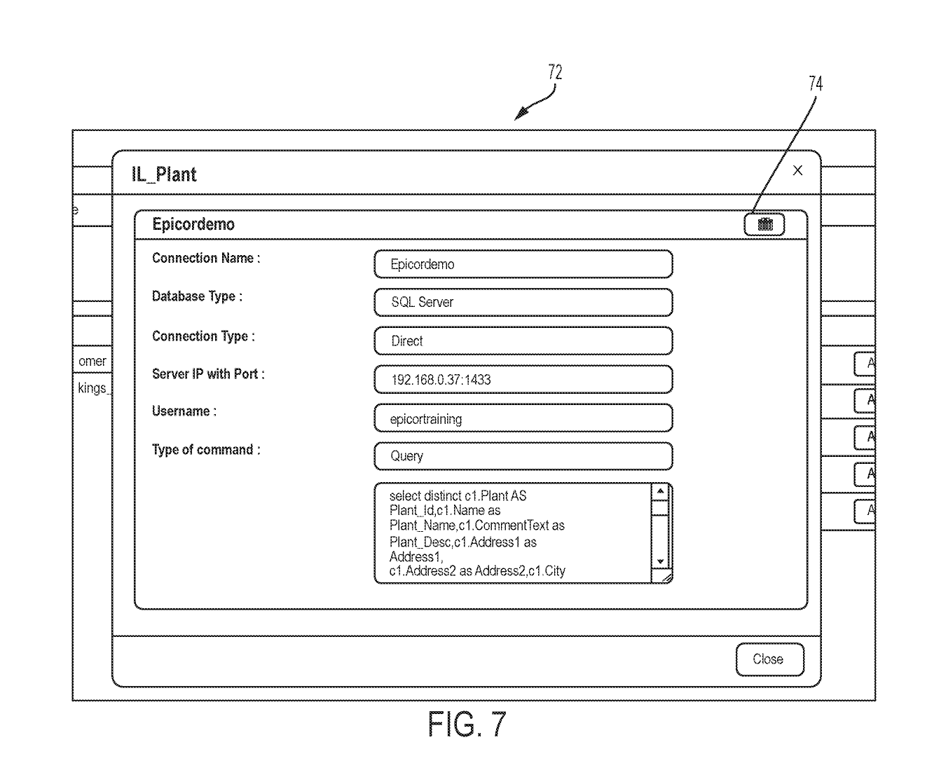

FIG. 7 shows an example of a dialog box 72 of a database query upload. The dialog box 72 shows details such as a connection name, a database type (i.e., a SQL Servicer, MySQL, or other database type), a connection type (i.e., a direct connection), a server IP with port Number, a username, a type of command (i.e., a query), and the details of the type of command (such as the details of the query to select the data). Such a mapped data source may be deleted through selecting a delete option 74.

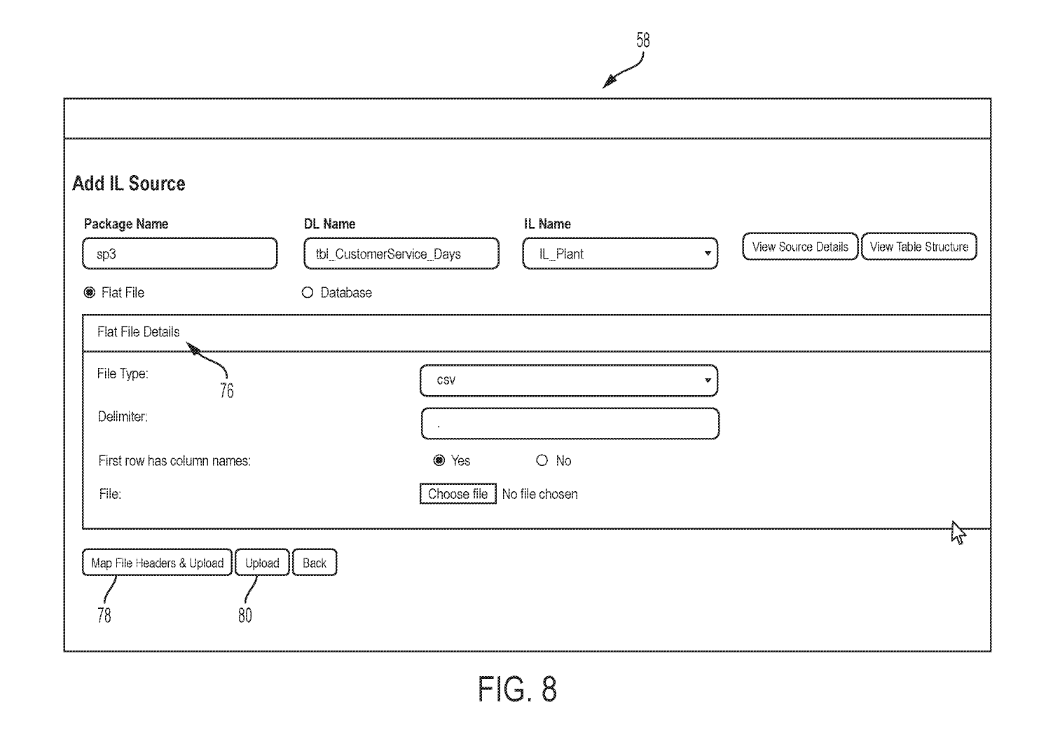

Referring again to FIG. 5, a user deciding to map an IL source by using a flat file selects the flat file radio button. As shown in FIG. 8, selection of the flat file radio button adds a Flat File Details screen 76 to the Add IL Source screen 58 of FIG. 5. The Flat File Details screen 76 presents an option to select a type of file to be uploaded (i.e., a .csv or other flat file type option), a delimiter to be used in the type of file selected, an option to select whether the selected file type includes a first row as columns names or not, and a location of the chosen file to be uploaded from, for example, a local drive. Flat File Details screen 76 also includes a Map File Headers & Upload button 78, an Upload button 80 to upload the selected file, and a Back button that will navigate a user to an Edit Standard Package page without uploading a file or query. Selection of the Map File Headers & Upload button 78 opens a window with IL table structure column names and data type along with a select box with column names from the selected flat file data source and a default value input box. From the select box, a user may map the IL table column name with the flat file column and may set a default value for the column.

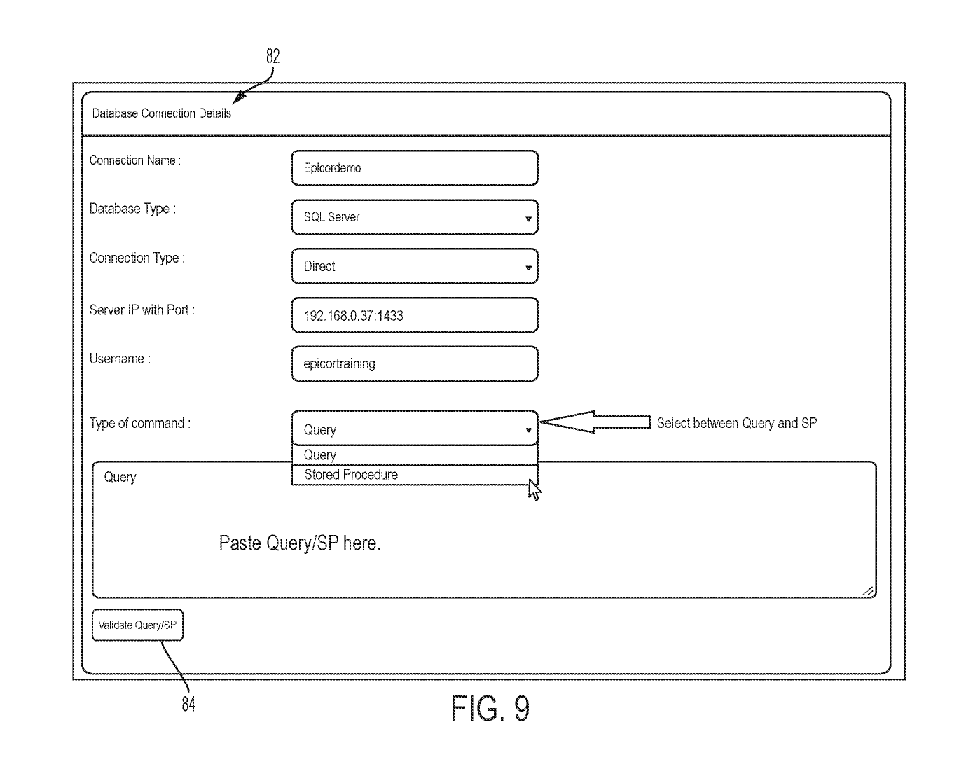

A database query may also be mapped as a data source to an IL table structure, as shown in FIG. 9. Selection of the database radio button of FIG. 5 causes a select box to appear below the database radio button from which a user may select a type of database connection from an existing list or may create a new connection.

When a user selects the type of database connection from the existing list, a Database Connection Details block 82 as shown in FIG. 9 is opened that shows details about the connection such as connection name, database type, connection type, server IP with port number, username, and type of command as either query or a stored procedure, with a field in which to paste a query or stored procedure. The user may select a Validate 84 button to check whether the query or stored procedure is executable for the selected IL table structure. A successful validation indicates the data source is mapped with the IL table structure. If a successful validation is not indicated, a user is to check or repaste the query or stored procedure and validate again through the Validate 84 button until achieving a successful validation.

When the user selects to create a new connection, another Database Connection Details block appears in which a user provides details such as a connection name, type of database (i.e., MYSQL, SQLSERVER, MS ACCESS, or ORACLE) form a given list, connection type (i.e., Direct or Tunnel), server IP address and port number, username, and password. Also presented is a Test Connection button to test whether the connection may be established and a Save Connection button to save the new connection if the test connection was successful. After saving a successful connection, a user may return to the Database Connection Details block 82 to validate the new connection as described above.

Referring again to FIG. 2, a user may select the Custom Package option 32 to create one or more custom tables from which to build dashboards. When selected, the Custom Package option 32 launches a screen with a list of existing custom packages and respective mapping details with options to edit, view, and delete the existing custom packages. The list provides vertical details and information as to whether the package is active, whether the table is mapped with a data source, whether the data in the table is process (i.e., done and added to the target table) or not (i.e., pending), and whether the package is scheduled, as described in greater detail below.

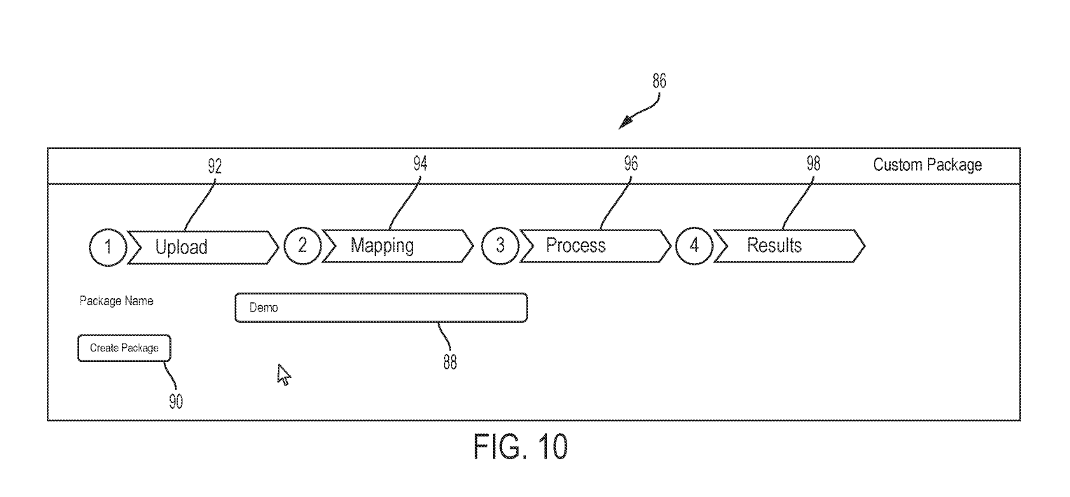

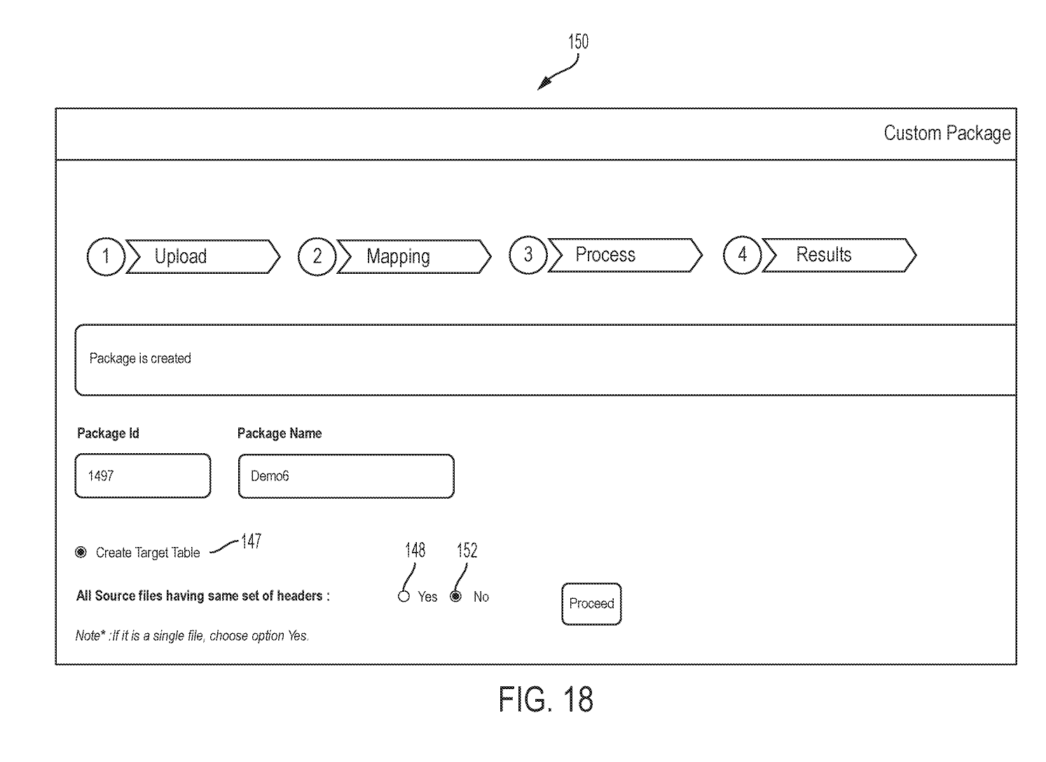

Referring to FIG. 10, selecting an option to create a new custom package launches a window 86 in which a user provides a new package name in a name box 88 and clicks on a Create Package button 90. Creating a custom package involves four stages as shown in the window 86, including Upload 92, Mapping 94, Process 96, and Results 98. Once a package is created, as shown in window 150 of FIG. 18 as an example, a user's package identification and package name may be checked through a create target table option 147 that inquires whether all source files have a same set of headers through selection of a Yes option 148 or a No option 152. As an example, if a single source file is being selected, the user should choose the Yes option 148.

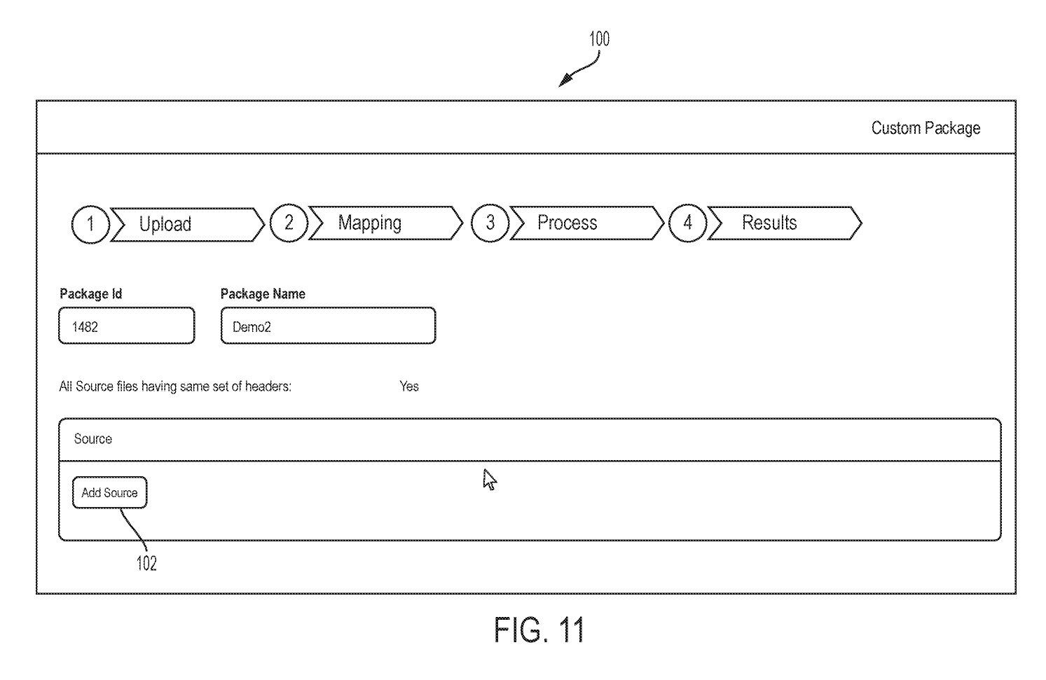

Referring to FIG. 11, in the Upload 92 stage, a user has selected the Yes option to indicate all source files have the same set of headers. The user is presented with a window 100 to add one or more of such source files containing the same set of headers through clicking an Add Source button 102. A pop up window may appear to select whether the source file to add is a flat file or a database query (or standard procedure), which selection will present the selected optional files to be added to the target table. The target table that is created will include the column names provided in the selected sourced file header or selected query columns.

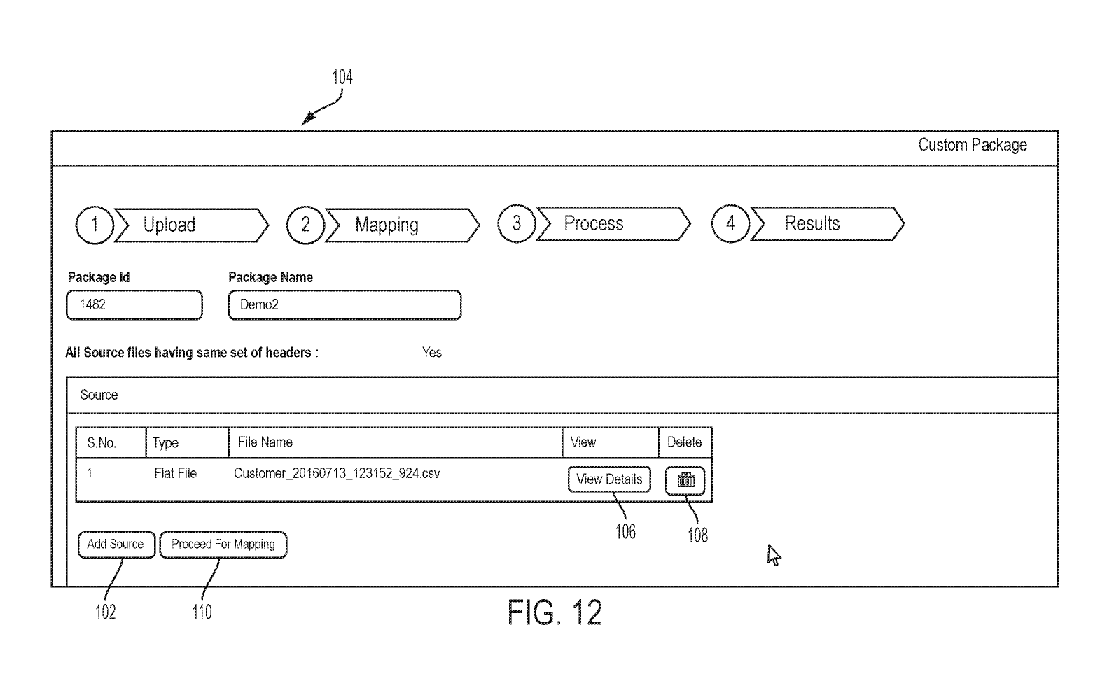

When the user selects the flat file option, a flat file details block appears from which the user may add a source file, choose a delimiter, select whether the source file includes a first row having column names, select the file path, and click on a Save & Upload button to upload the file. Once the flat file is uploaded, as shown in screen 104 of FIG. 12, a user may check which file has been uploaded through a View Details option 106, may delete the file through delete option 108 in case an incorrect file has been uploaded, and/or may add one or more source files by selecting the Add Source button 102 again.

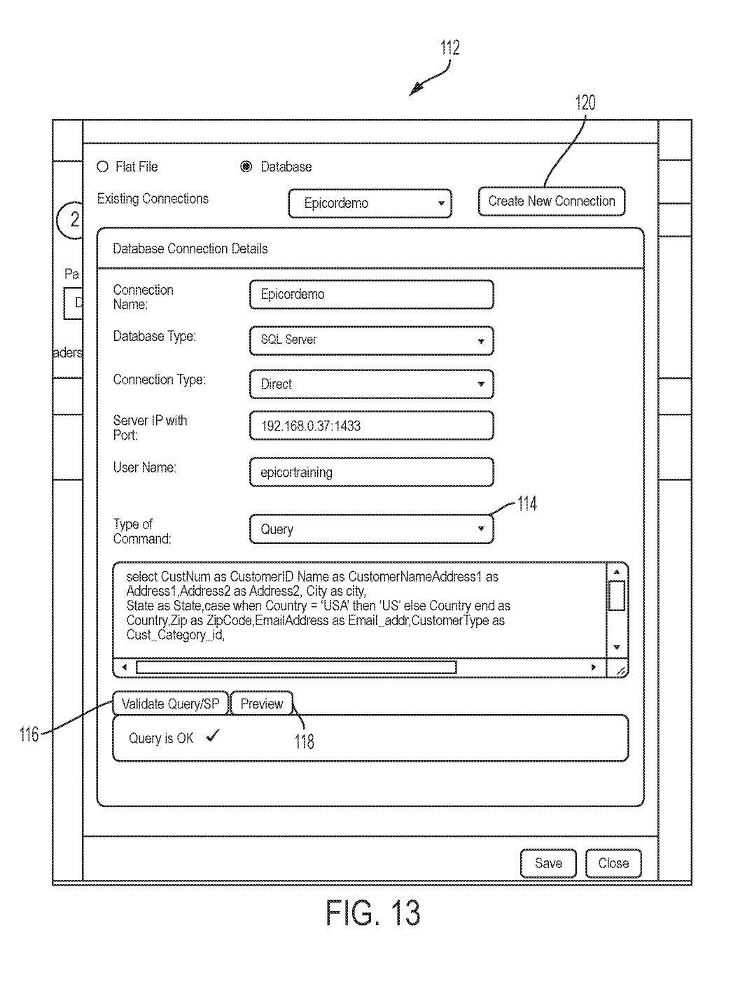

When the user selects the database option, a details block appears from which the user may add a source file from existing connections or through creation of a new connection. For example, selection from existing connections opens a window 112 that shows details of the existing connection such as connection name, database type, connection type, server IP and port number, username, and the like as shown in FIG. 13. The user selects between a query or stored procedure option under a type of command select box 114 and pastes the query or stored procedure based on the selection. The user may then Validate the query or stored procedure through a Validate button 116. If the query or stored procedure is successfully validated, the user may select the Preview button 118 such that a popup window with the first 10 records of the data selected from the user's pasted query may appear for a user confirmation of the validation before the user saves the source to create the target table.

A user may wish to create a new connection through the Create a New Connection button 120. The user will then need to fill out requested details such as connection name, database type, connection type, server IP and port number, username, and the like, and will need to test and save the connection.

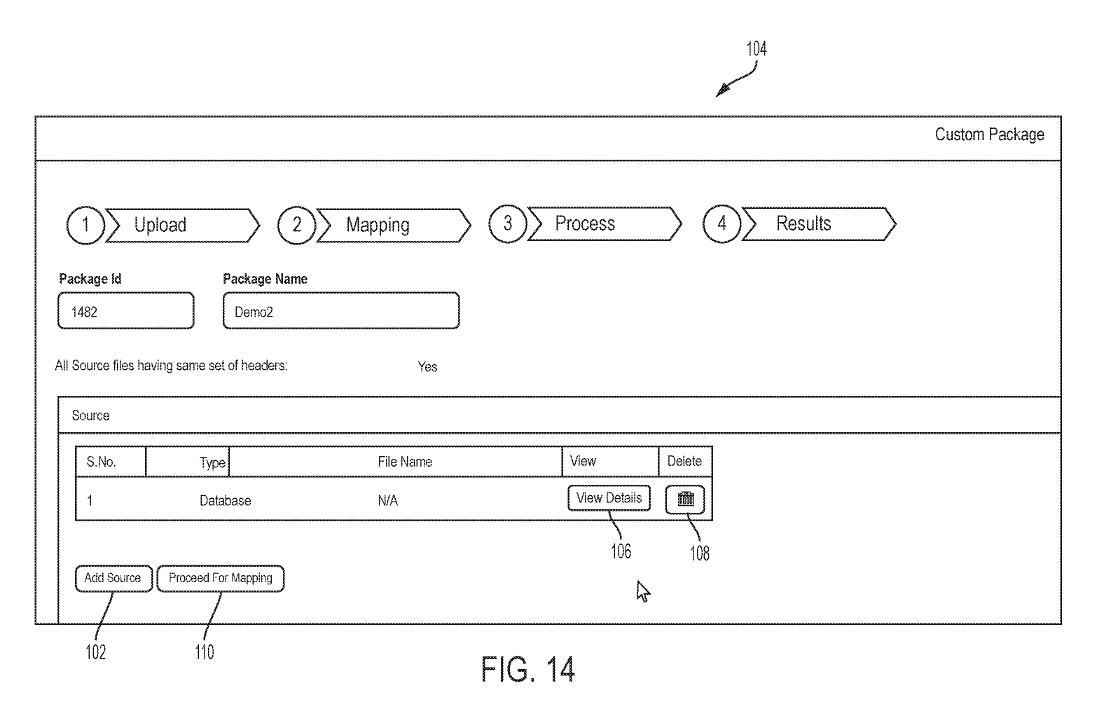

Referring to FIG. 14, which shows the screen 104 of FIG. 12 after a database source has been added as described above, once the user has uploaded a desired number of source files, the user may select the Proceed for Mapping button 110 to proceed to the Mapping 94 stage. In the Mapping 94 stage, a user has successfully uploaded a data source file as described above from which a target table may be created through Mapping 94.

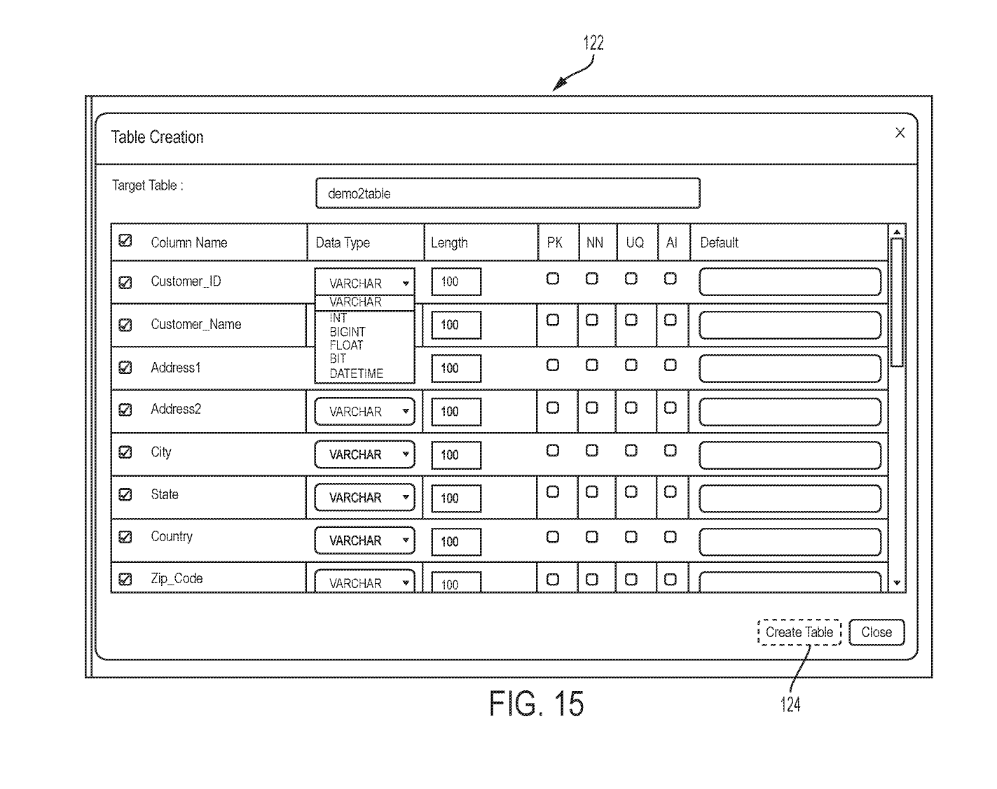

Referring to FIG. 15, selection of the Proceed for Mapping button 110 (of FIG. 14) causes a popup window 122 to open that shows the user the uploaded data set column headers. The user may select a number of columns desired for the target table, and the user is given an option to select data type and default values for the columns. If a user does not select a proper data type for each column, all columns may be default be assigned a VARCHAR data type. Once all options have been selected, the user is to select the Create Table 124 option and give a name to the table. A table is created and the user will be able to view the table structure (including details such as columns, data types, and column sizes) through selecting an View Table Structure button.

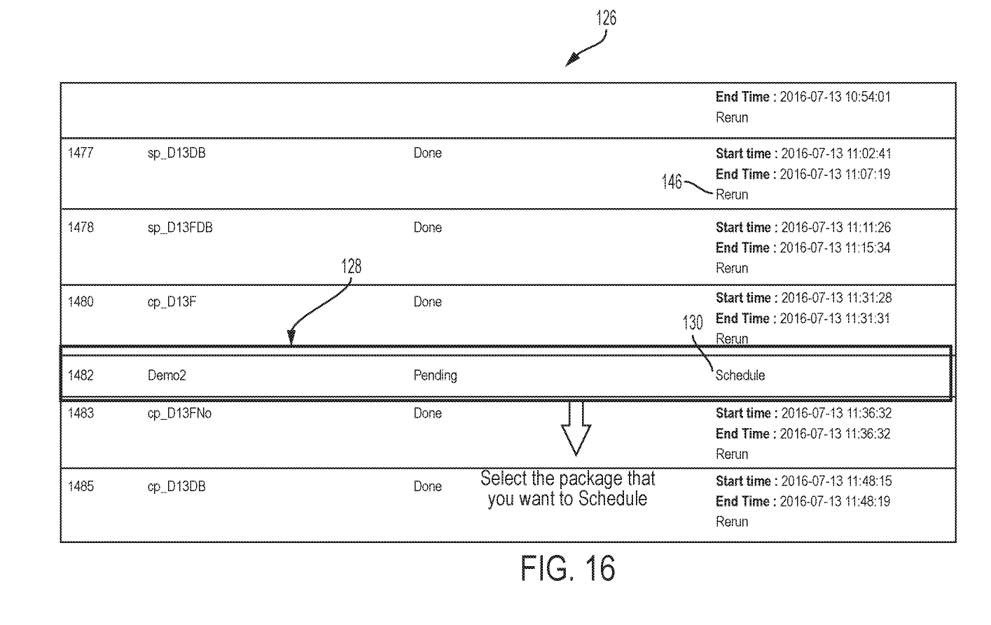

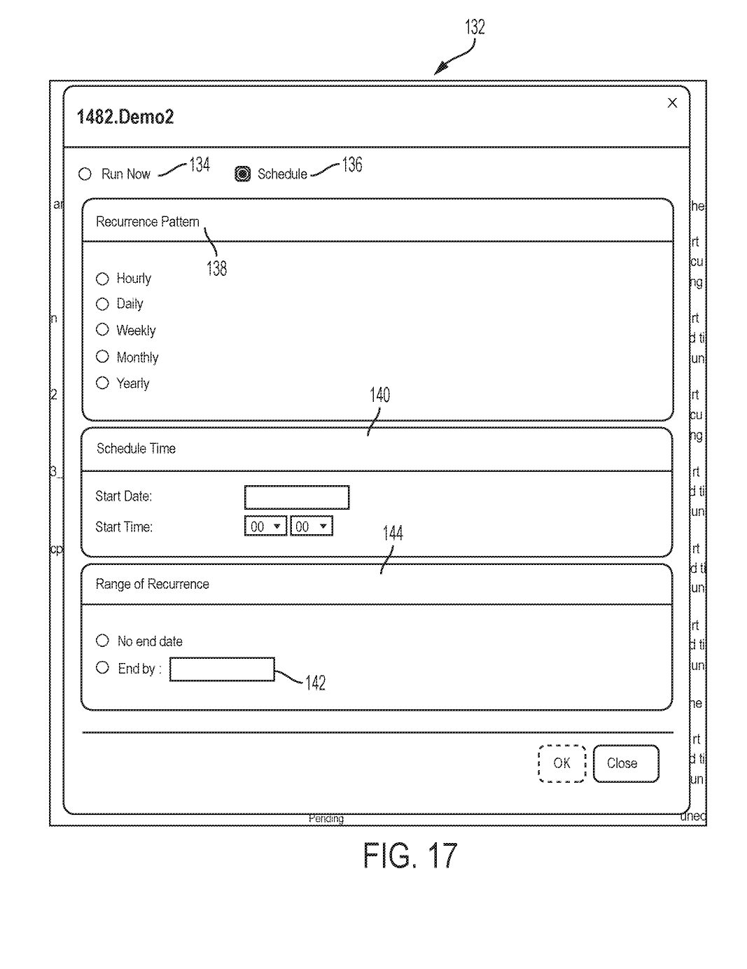

After the user has created the target table and added one or more source files to the target table in the Mapping 94 stage, the user proceeds to the Process 96 stage. Referring to a screen 126 of FIG. 16, a user may Process 96 the created target table by selecting a pending package 128 that the user desires to schedule through selecting a schedule button or link 130. For example, as shown in a screen 132 of FIG. 17, a user may either process the data immediately through a Run Now button 134 or may schedule the processing of data to the target table by a timely basis through a Schedule button 136. The timely basis may be hourly, daily, weekly, monthly, or yearly, for example, as may be selected through a Recurrence Pattern menu option 138. Selection of the Schedule button 136 processes the data whenever the user wishes to add the latest data to the target table with a specified Start Schedule date and time 140 and optional end date 142 to set a Range of Recurrence 144. Referring again to FIG. 16, selection of a Rerun 146 link will process data again (i.e., of tables have a done status) to add to the target table. After the Process 96 stage such that the data has been added to the target table, the ETL data warehouse tool 16 is ready to build dashboards in the Results 98 stage by using the created target table and added data. For example, after the user has opted between the Run Now button 134 or the Schedule button 136, the data is added to the target table in the Results 98 stage and the user is ready to build dashboards by using the created target table and added data.

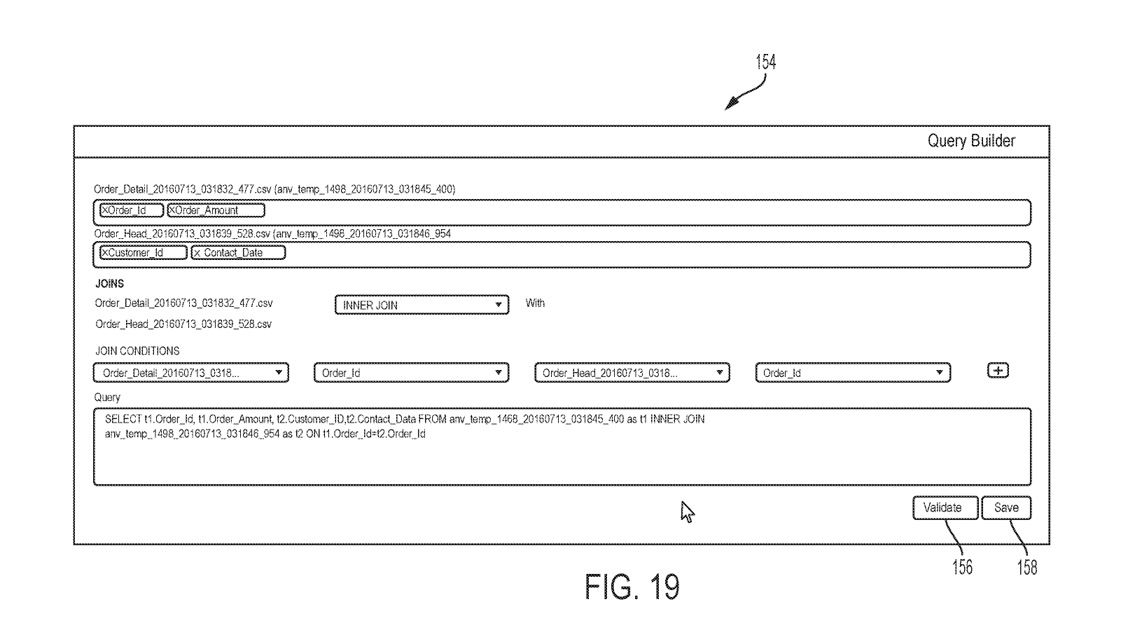

Referring again to the Upload 92 stage and the window 150 of FIG. 18, the user may select the No option 152 when creating the target table in the Upload 92 stage, indicating multiple files to be added do not all contain the same set of headers. If the user selects the No option 152, the user ten selects a Proceed button to add source data in a similar manner as if the Yes option 148 was selected and as described above. The source data may include at least two or more flat files and/or queries that have different column headers. Selection of a Proceed for Mapping button (similar to the button 110 of FIG. 14) navigates the user to a query builder page 154 from where the user may select which columns are desired from the different sources. The user should not select common columns from the different sources as such an attempt would not permit creation of the target table. The selected columns may be joined based on a common column indication or conduction (such as a common column identification) as shown in FIG. 19. Once the user has selected the desired columns and join condition, the user may validate the query through the Validate button 156. If the query is correct and successfully validated a green color box may appear. Otherwise, for a negative validation, red colored box may appear prompting the user to check the query and validate the query until it is correct. Once the query is validated, the user may select the Save button 158 to successfully add the source.

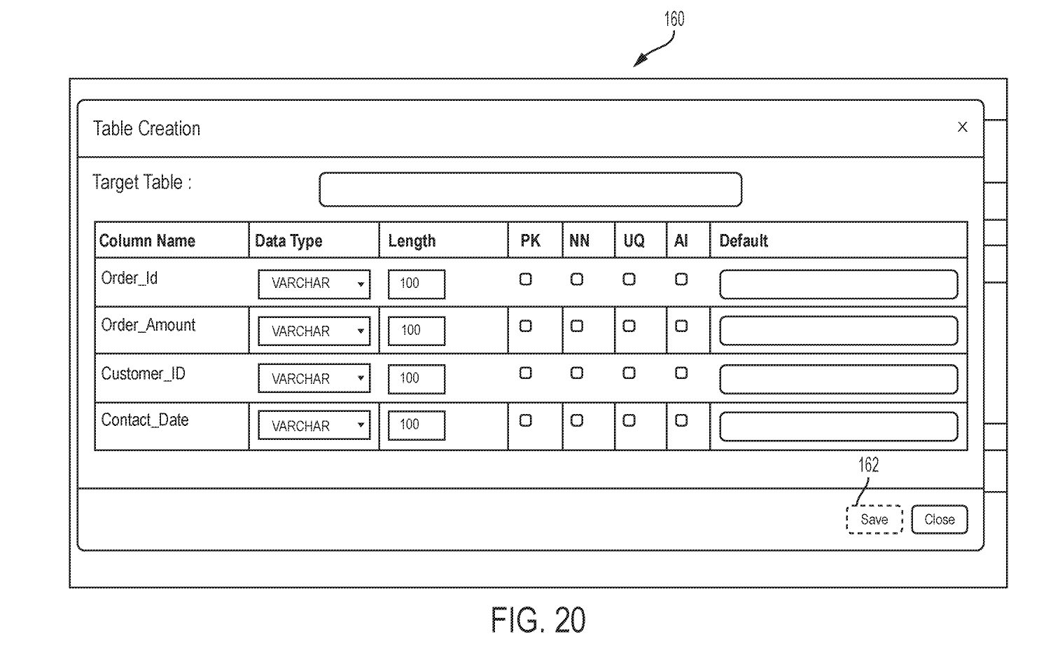

Referring to FIG. 20, once the source has been successfully added, the user may create the target table in a window 160 with a table name and desired number of columns from those selected in the query builder page 154. Further, the user may set a data type of each column and default values.

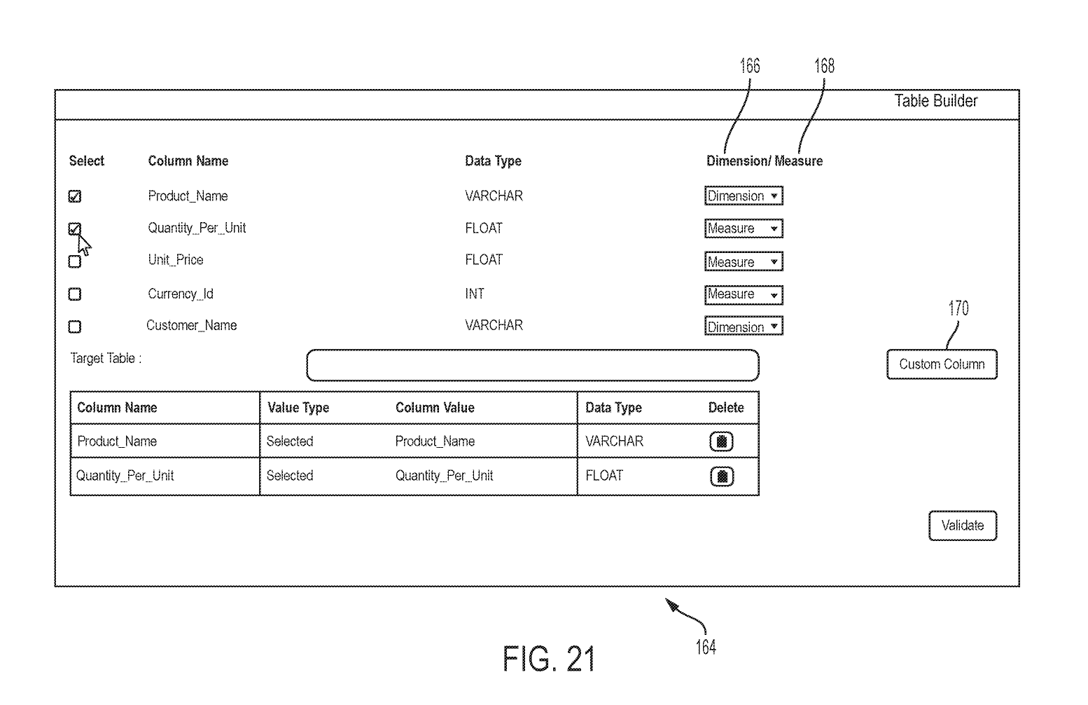

Selection of the Save button 162 navigates the user to a Target Table Creation page 164 as shown in FIG. 21. The user may select the columns desired from a list on the Target Table Creation page 164 and choose between Dimension 166 or Measure 168 for each column. For example, selection of Dimension 166 indicates the column includes one or more categories for dashboards that may be used for sorting and reporting purposes. Further, selection of Measure 168 includes the column includes a numerical measurement for reporting. A data type of VARCHAR only allows for a Dimension 166 field. A data type of INT allows a user to select between a Dimension 166 and a Measure 168 field option. Thus, the Target Table Creation page 164 may create a derived target table from the actual target table having a user defined table.

Through a Custom Column button 170, a user is presented with an option to add a custom column to the derived target table. Through this option, the user may create or write their own formula based on existing columns or can input a constant data. The user must present a unique column name for this option that does not exist in the target table, select a data type, and select the value type as Derived, Custom, or Default. A Derived value type add type of aggregates and operations from a selected column to derive the new column. A Custom value type allows a user to evaluate any expression with or without existing columns. For the with existing columns option, the user must input the required column name. The user may perform multiple operations on the column and build a custom column with derived data. If the user selects the without existing columns option, the user may provide any constants as data. A Default value type is selected when the user only has constants to be added as a new column.

The user must validate and save the derived target table to create the desired derived target table. The user will then be presented with three options of My Packages to navigate the user to the list of packages page, Schedule to navigate the user to the run now or schedule page, or Continue to continue to create one or more derived target tables (that may all be found under the same package that has been created). To add data or process the target tables, the user must schedule such procedures in a similar manner as described above for selection of the Yes option 148.

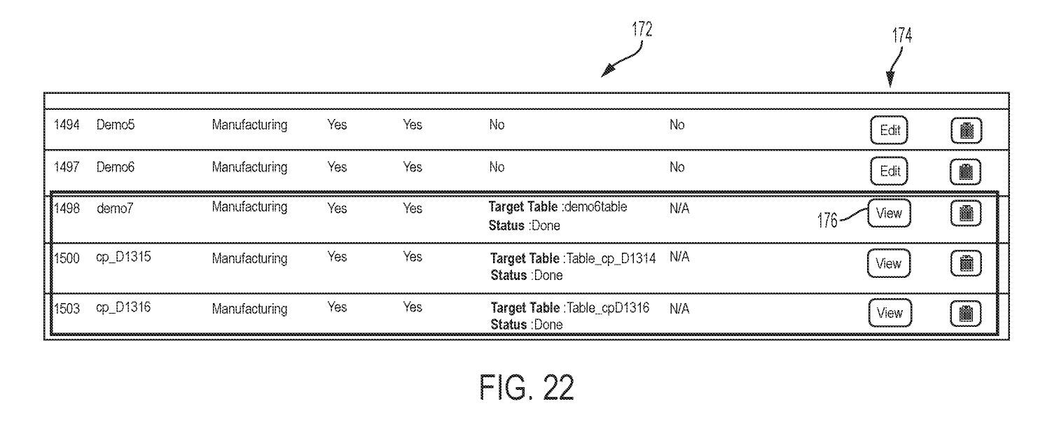

Referring to a window 172 of FIG. 22, a user may select to either Edit 174 or View 176 a custom package. Before schedule, to Edit 174, the user may observe a pending status for the custom package with an associated target table name shown with the package. Selection of the Edit 174 button allows for scheduling to process the data. Once scheduling is set, the status changes to done as shown in FIG. 22, and the user may select a Done status link to view the number of records inserted and failed in the target tables by showing both target table and derived target table details. The user may also view the target table, table structure details, and uploaded source by selecting the View 176 button associated with each custom package name. The user may also select to delete a custom package, such as an unused custom package, though the target table and the derived target table will not be deleted from the database such that user created dashboards, as described in greater detail below, will still operate.

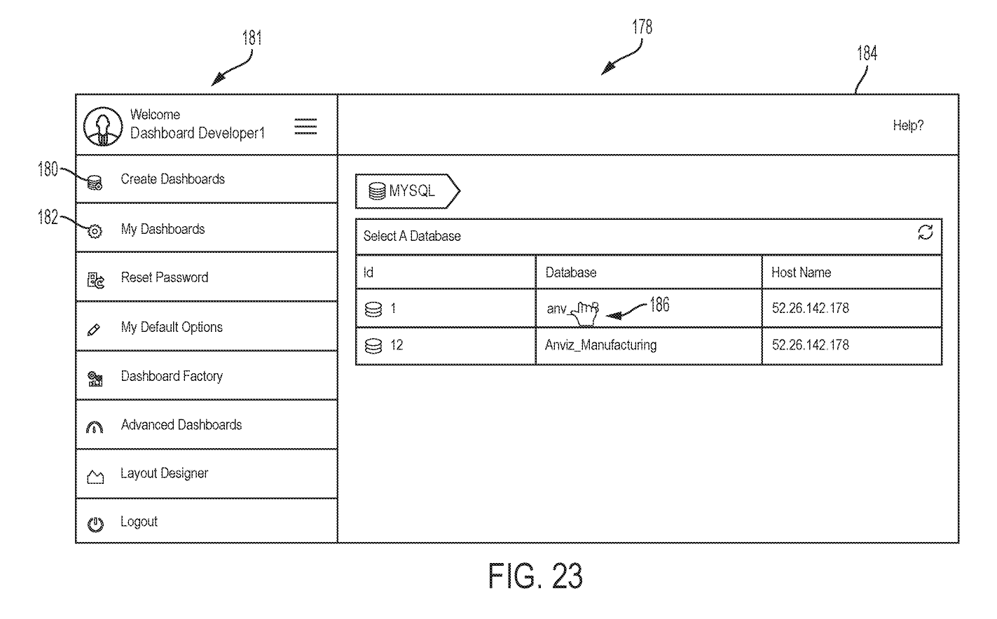

In the Results 98 stage, and referring to FIGS. 1 and 23, a user may develop his or her dashboard for real-time reporting through the visualization engine 20. The user may log into or select to navigate to a Dashboard Developer 178 joining the DL module 18 of the ETL data warehouse tool 16 and the visualization engine 20. The Dashboard Developer 178 presents the user with a Create Dashboards option 180. The source data (as either a flat file or database) and database tables (with data arranged in columns and rows and categorized as dimensions or measures) described above form the building blocks from which to create dashboards. In a select source data screen, the user is presented with data source type options such as EXCEL, ORACLE, SQL, MYSQL, MICROSOFT (MS) SQL SERVER, and MS ACCESS. Single or multiple tables from the tables in the selected databases include data fields including categories of dimensions and measures from which to create dashboards. Dimensions are categorical data, and measures represent numerical data. The dashboards may be configured in terms of optional chart types, background, themes and the like.

After the user logs in to the Dashboard Developer 178, a home page may show a list of options on the left navigation pane 181 such as the Create Dashboards option 180, a My Dashboards option 182 to view existing user dashboards, and other setting options. Should the user select the Create Dashboards option 180, the user is directed to select a data source. For example, in the screen 184 of FIG. 23, the user has selected a MySQL option as the data source. The user is next directed to select a database from the data source. In the example of FIG. 23, the user selects the database 186 named anv_DB.

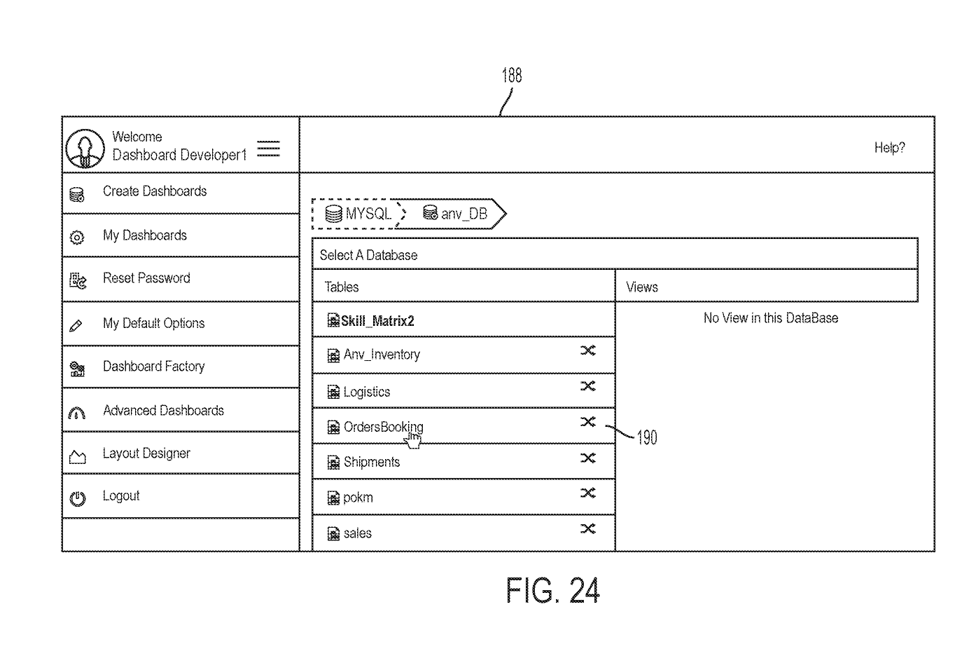

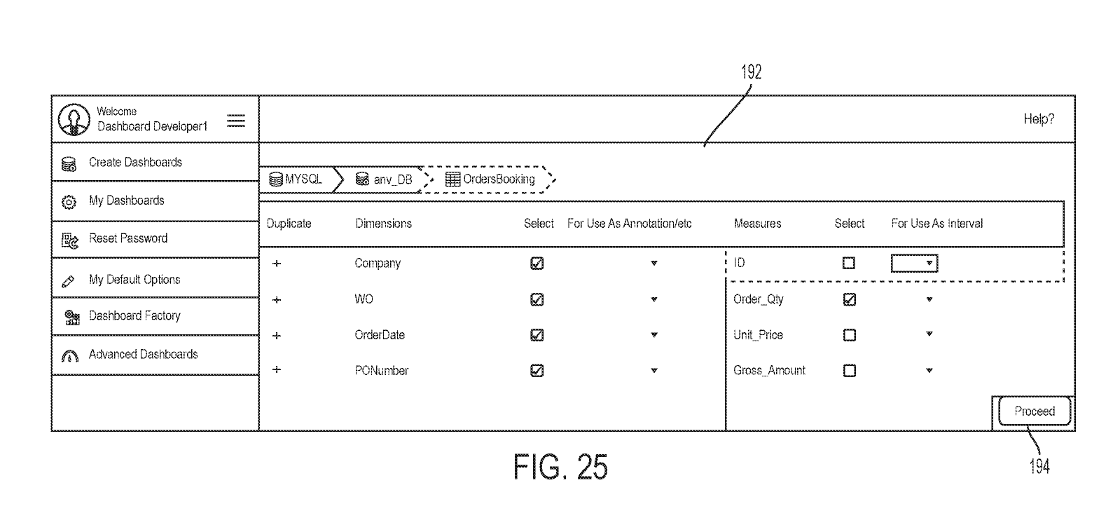

Referring to FIG. 24, the user is directed to a table selection window 188. In the example of FIG. 24, the user selects the table 190 named OrdersBooking. Referring to FIG. 25, the user proceeds to a dashboard selection page 192. As a non-limiting example, from the table 190 named OrdersBooking and through the dashboard selection page 192, a user may wish to create a dashboard to view a measure of Order Quantity by the dimensions of Company, Work Order (WO), Order Date, and Purchase Order (PO) Number. Thus, the user selects all of these options in the dashboard selection page 192 and selects the Proceed button 194.

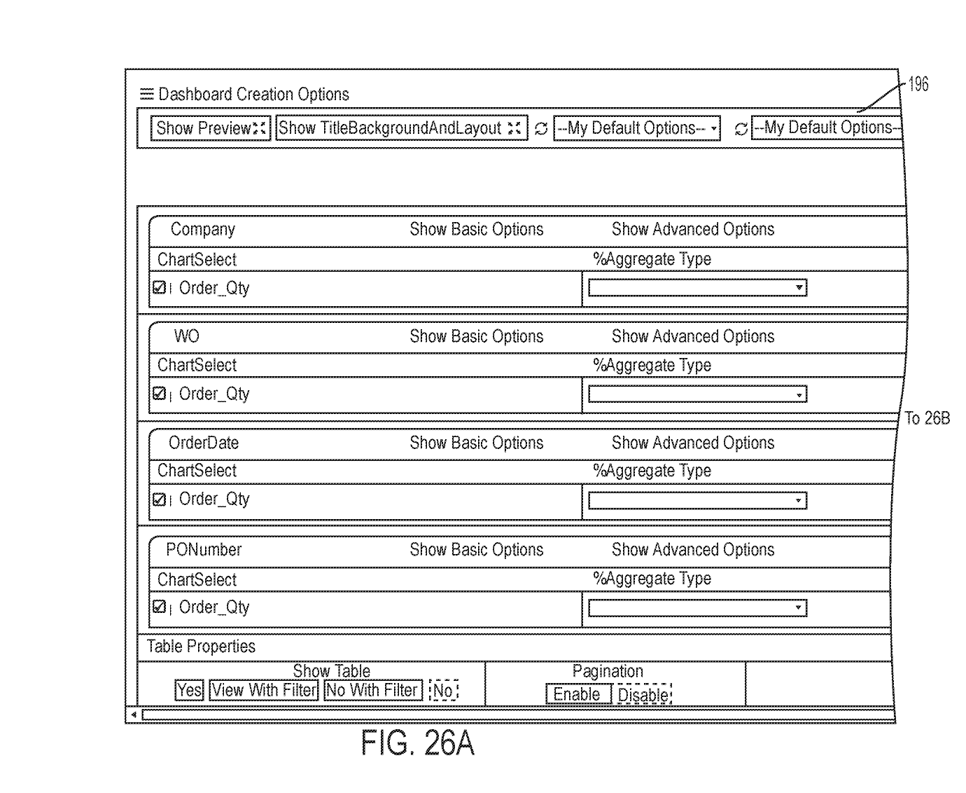

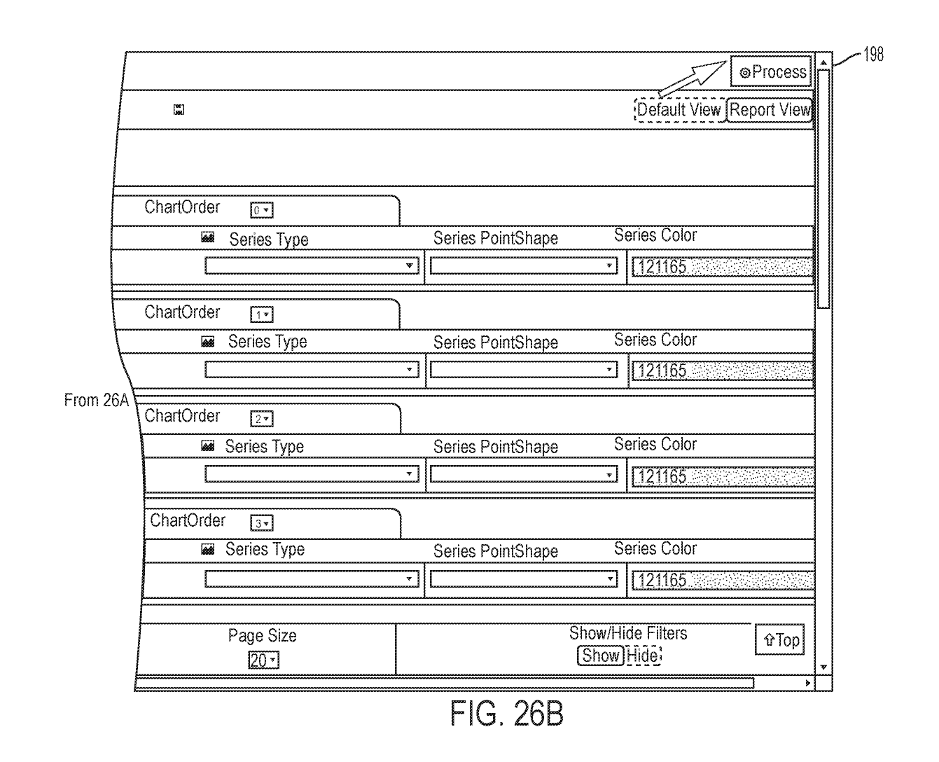

Referring to FIG. 26, on a dashboard creation options screen 196, the user is shown a default configuration listing four separate reports, each reporting a selected dimension by the selected measure. The user may create a dashboard using a default configuration by selecting a Process option 198. The Process option 198 in conjunction with the DL module 18 and the visualization engine 20 presents graphical visualizations of the reports that are modifiable and are able to be presented per varying selectable reporting options. Such reports and reporting options may be saved and viewed by a user through the dashboards. As described above, the visualization engine 20 may further include business performance management components, such as collaboration and communication tools, push based alerts, and a threshold management system. For example, one or more users may collaborate across a chat space while viewing the same dashboard. Additionally or alternatively, thresholds may be integrated into the reporting structure such that alerts may be issued via email, text, or like notifications to appropriate personnel once such thresholds have been exceeded. Such alerts and thresholds permit a preventative versus a reactive approach as well as a more timely and potentially immediate approach to situations in which thresholds have been exceeded.

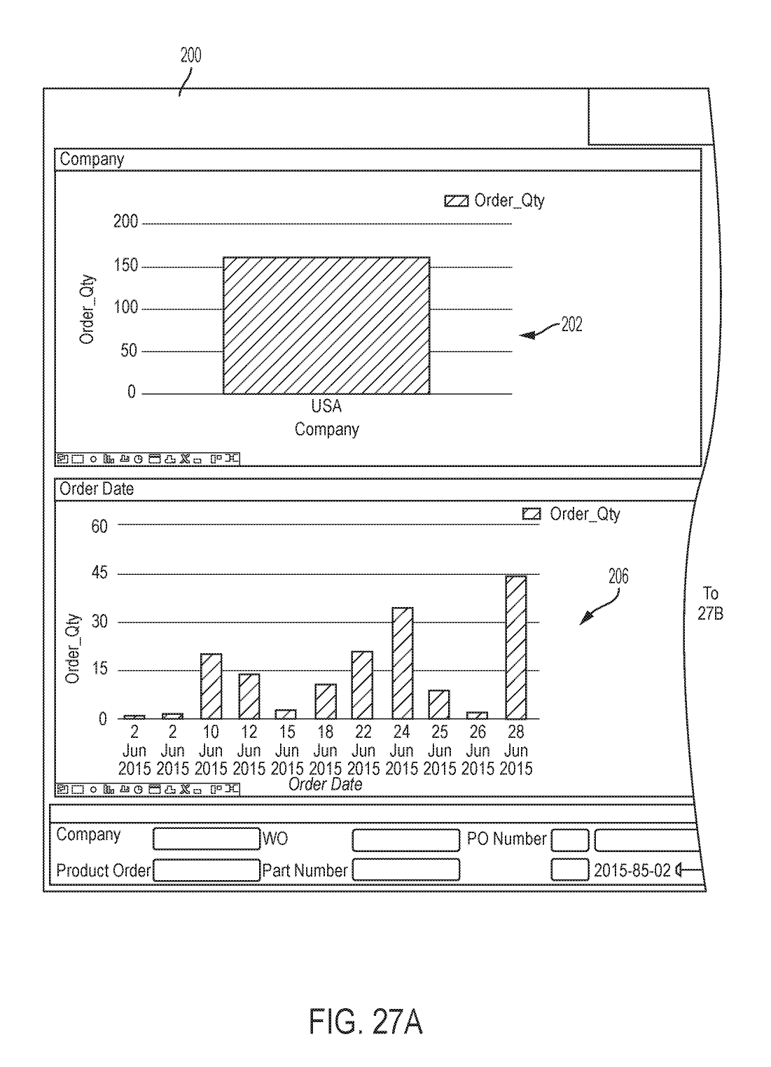

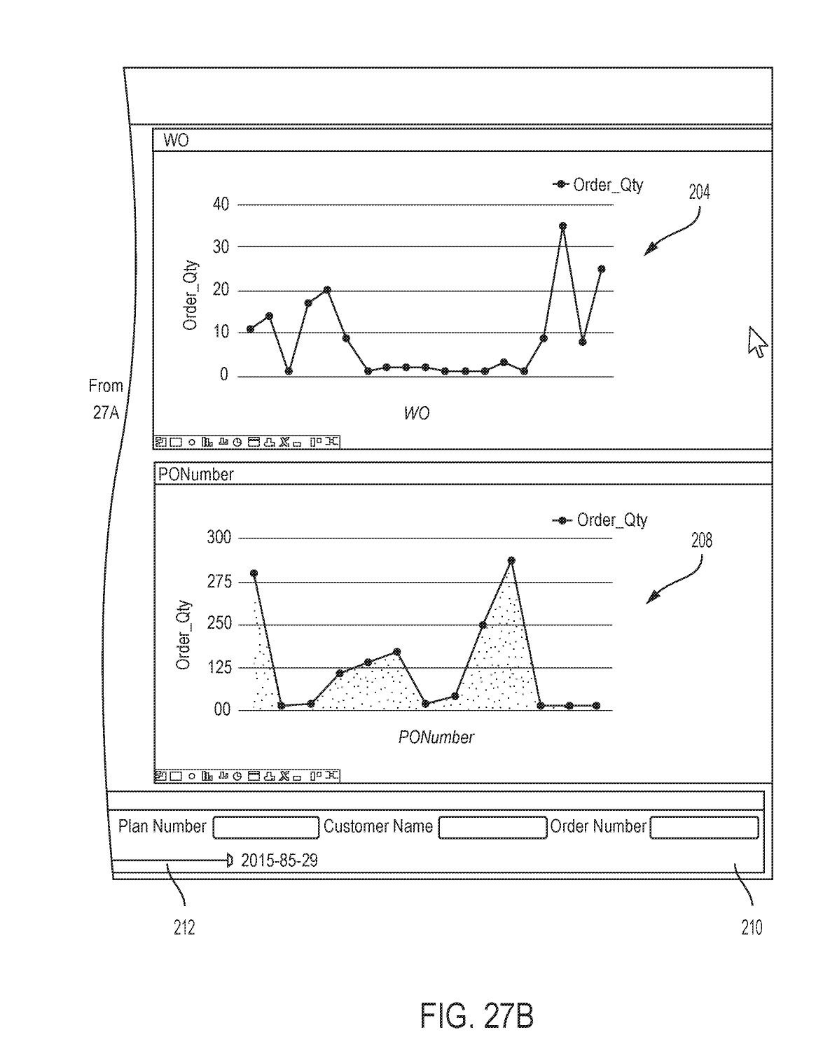

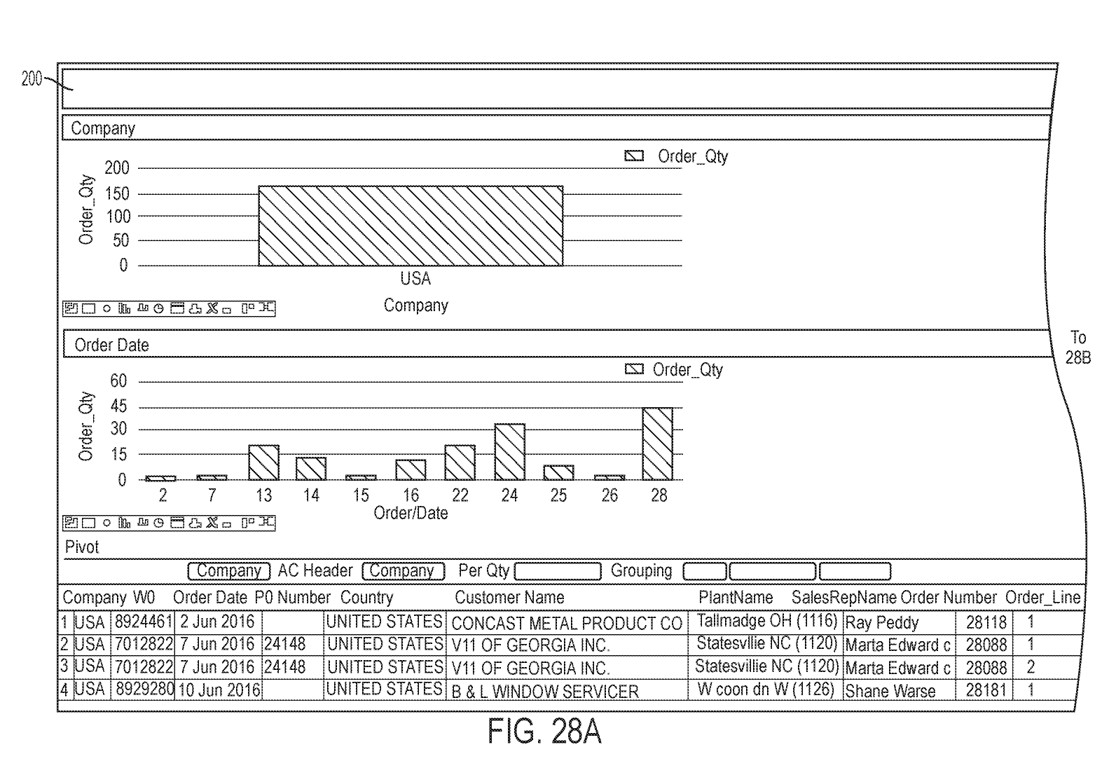

FIG. 27 shows one such viewing example. Four charts are presented on a dashboard screen 200. The first chart 202 is a bar chart showing the Company dimension on the x-axis and the Order Quantity measure on the y-axis. The second chart 204 is a line chart showing the WO dimension on the x-axis and the Order Quantity measure on the y-axis. The third chart 206 is a bar chart showing the Order Date dimension on the x-axis and the Order Quantity measure on the y-axis. The fourth chart 208 is a line chart showing the PO Number dimension on the x-axis on the x-axis and the Order Quantity measure on the y-axis. The dashboard screen 200 may be customized to display more than a visual representation of charts. For example, filters and tables may also be displayed as a final dashboard output, including pivot tables. Such tables may include drop-down lists of dimensions and measures available in the underlying data source. A data grid may be configured through use of a table filled with options to select the dimensions and measures to be on the tabled and filters in the dashboard screen 200. The table includes a complete list of all the dimensions and measures available in the underlying data source. A user may select appropriate selections to display dimensions, measures, filters for dimensions or measures, or a pivot option on the dashboard screen 200.

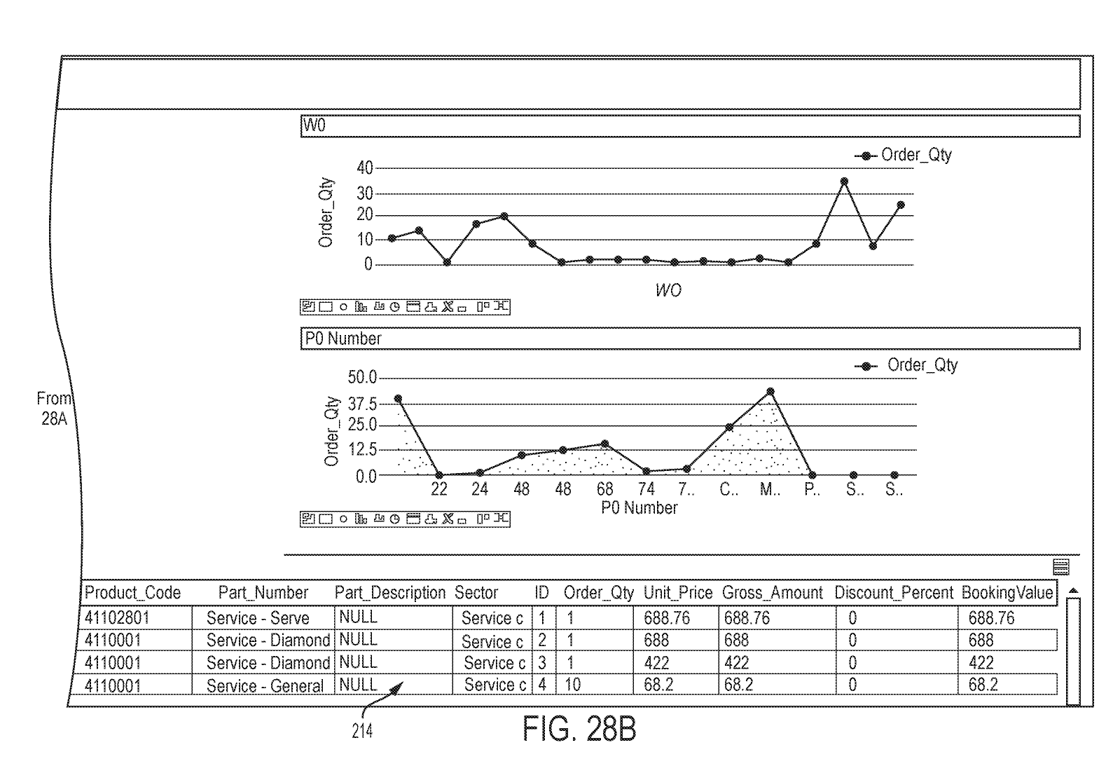

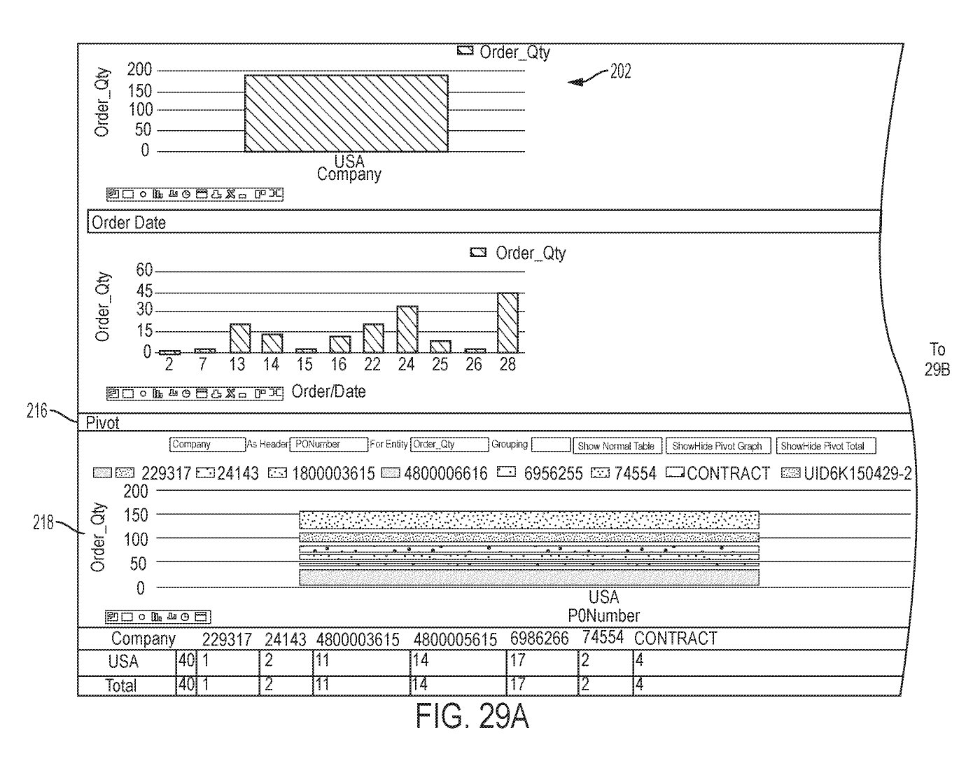

Referring to FIG. 27, a show filters option has been selected to display a list of filters 210 for each dimension available in the underlying data. Date field filters may be represented as sliding bar components 212 for which respective ends are indicative a start date and an end date. Selecting a hide filters option results in a dashboard only including charts and optionally tabular data, such as data 214 of FIG. 28, but not including dimension based filters from which to narrow down presented data on the dashboard.

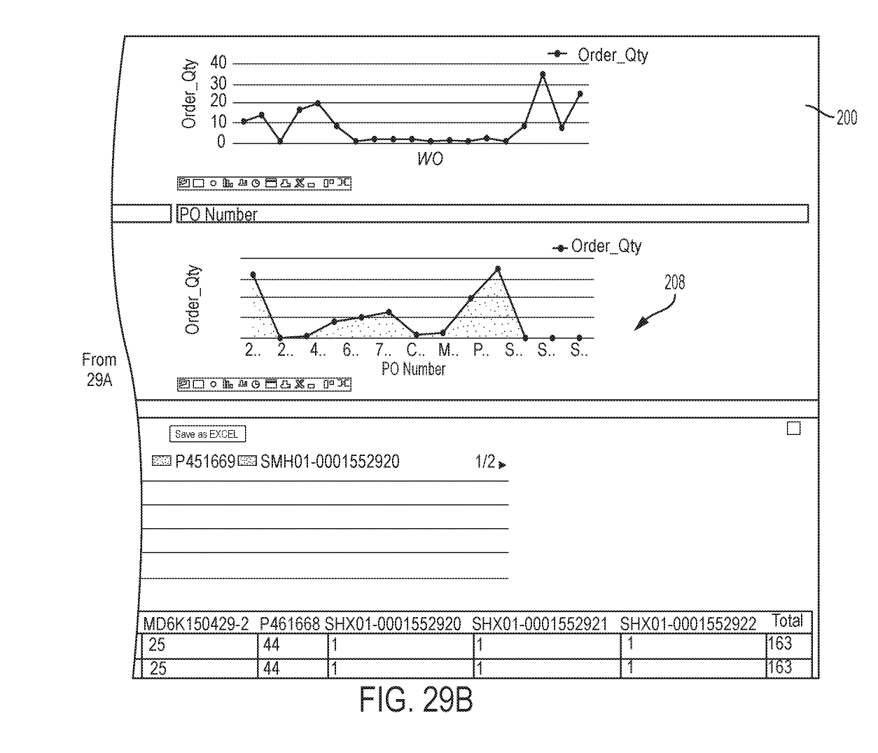

FIG. 29 shows an example in which a pivot option 216 is used to perform efficient and quick data manipulation to create a customized data matrix, which pivoted data appears in a graphical form as a pivot chart 218. For example, the pivot chart 218 represents a narrowing of the first chart 202 showing the Company dimension by the Order Quantity measure to overlap the Purchase Order dimension of the fourth chart 208 that are summed as a grouping option to overlay onto the bar chart of the first chart 202 to create the pivot chart 218. Other grouping options to combine dimensions may include average, minimum, or maximum. For example, a legend is created to color code or otherwise indicate PO dimensions within the pivot chart 218. Thus, the pivot chart 218 visually represents a combination of dimensions and a measure to create a data matrix and represent a pivot form of the table to show, for example, two dimensions in the x-axis against a measure in the y-axis.

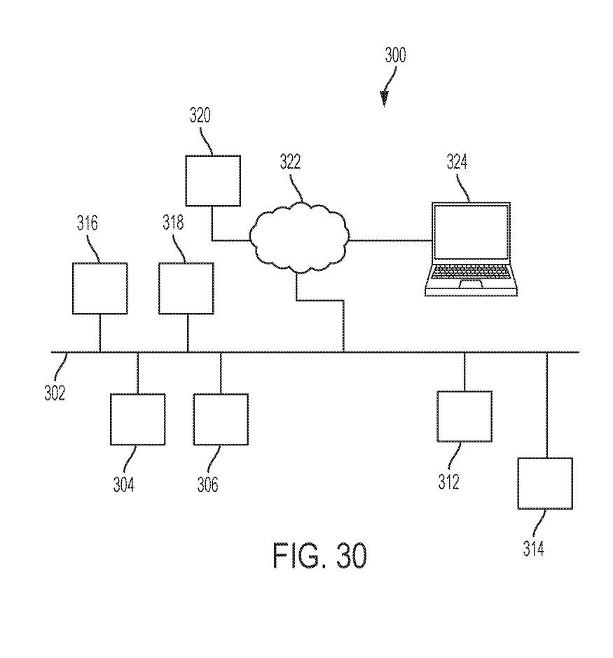

Referring to FIG. 30, a system 300 for implementing computer and software-based methods to utilize the big data analytical platform tools, as shown in FIGS. 1-29, is illustrated as being implemented along with using a graphical user interface (GUI) displaying a home screen for a user to access the platform and/or view a dashboard as described herein and that is accessible at a user workstation (e.g., a mobile and/or stationary computing device such as a computer 324), for example. The system 300 includes a communication path 302, one or more processors 304, a memory component 306, an extract-transform-load (ETL) data warehouse component 312, a storage or database 314, a visualization engine 316, a network interface hardware 318, a network 322, a server 320, and at least one computer 324. The various components of the system 300 and the interaction thereof will be described in detail below.

While only one application server 320 and one user workstation computer 324 is illustrated, the system 300 can include multiple workstations and application servers containing one or more applications that can be located at geographically diverse locations across a plurality of physical sites. In some embodiments, the system 300 is implemented using a wide area network (WAN) or network 322, such as an intranet or the Internet, or other wired or wireless communication network that may include a cloud computing-based network configuration. The workstation computer 324 may include digital systems and other devices permitting connection to and navigation of the network. Other system 300 variations allowing for communication between various geographically diverse components are possible. The lines depicted in FIG. 3 indicate communication rather than physical connections between the various components.

As noted above, the system 300 includes the communication path 302. The communication path 302 may be formed from any medium that is capable of transmitting a signal such as, for example, conductive wires, conductive traces, optical waveguides, or the like, or from a combination of mediums capable of transmitting signals. The communication path 302 communicatively couples the various components of the system 300. As used herein, the term “communicatively coupled” means that coupled components are capable of exchanging data signals with one another such as, for example, electrical signals via conductive medium, electromagnetic signals via air, optical signals via optical waveguides, and the like.

As noted above, the system 300 includes the processor 304. The processor 304 can be any device capable of executing machine readable instructions. Accordingly, the processor 304 may be a controller, an integrated circuit, a microchip, a computer, or any other computing device. The processor 304 is communicatively coupled to the other components of the system 300 by the communication path 302. Accordingly, the communication path 302 may communicatively couple any number of processors with one another, and allow the modules coupled to the communication path 302 to operate in a distributed computing environment. Specifically, each of the modules can operate as a node that may send and/or receive data.

As noted above, the system 300 includes the memory component 306 which is coupled to the communication path 302 and communicatively coupled to the processor 304. The memory component 306 may be a non-transitory computer readable medium or non-transitory computer readable memory and may be configured as a nonvolatile computer readable medium. The memory component 306 may comprise RAM, ROM, flash memories, hard drives, or any device capable of storing machine readable instructions such that the machine readable instructions can be accessed and executed by the processor 304. The machine readable instructions may comprise logic or algorithm(s) written in any programming language such as, for example, machine language that may be directly executed by the processor, or assembly language, object-oriented programming (OOP), scripting languages, microcode, etc., that may be compiled or assembled into machine readable instructions and stored on the memory component 306. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. In embodiments, the system 300 may include the processor 360 communicatively coupled to the memory component 306 that stores instructions that, when executed by the processor 304, cause the processor to perform one or more tool functions as described herein.

Still referring to FIG. 3, as noted above, the system 300 comprises the display such as a GUI on a screen of the computer 324 for providing visual output such as, for example, one or more document for revising, other information, graphical reports, messages, or a combination thereof. The computer 324 may include one or more computing devices across platforms, such as mobile smart devices including smartphones, tablets, laptops, and/or the like.

The GUI may present a user with a home screen, for example, as described herein, which home screen may display one or more views associated with the ETL data warehouse component 312 and/or the visualization engine 316, as described in greater detail above. The display on the screen of the computer 324 is coupled to the communication path 302 and communicatively coupled to the processor 304. Accordingly, the communication path 302 communicatively couples the display to other modules of the system 300. The display can include any medium capable of transmitting an optical output such as, for example, a cathode ray tube, light emitting diodes, a liquid crystal display, a plasma display, or the like. Additionally, it is noted that the display or the computer 324 can include at least one of the processor 304 and the memory component 306. While the system 300 is illustrated as a single, integrated system in FIG. 30, in other embodiments, the systems can be independent systems. As will be described in further detail below, the processor 304 may process the input signals received from the system modules and/or extract information from such signals.

The system 300 includes the network interface hardware 318 for communicatively coupling the system 300 with a computer network such as network 322. The network interface hardware 318 is coupled to the communication path 302 such that the communication path 302 communicatively couples the network interface hardware 318 to other modules of the system 300. The network interface hardware 318 can be any device capable of transmitting and/or receiving data via a wireless network. Accordingly, the network interface hardware 318 can include a communication transceiver for sending and/or receiving data according to any wireless communication standard. For example, the network interface hardware 318 can include a chipset (e.g., antenna, processors, machine readable instructions, etc.) to communicate over wired and/or wireless computer networks such as, for example, wireless fidelity (Wi-Fi), WiMax, Bluetooth, IrDA, Wireless USB, Z-Wave, ZigBee, or the like.

Still referring to FIG. 30, data from various applications running on computer 324 can be provided from the computer 324 to the system 300 via the network interface hardware 318. The computer 324 can be any device having hardware (e.g., chipsets, processors, memory, etc.) for communicatively coupling with the network interface hardware 318 and a network 322. Specifically, the computer 324 can include an input device having an antenna for communicating over one or more of the wireless computer networks described above.

The network 322 can include any wired and/or wireless network such as, for example, wide area networks, metropolitan area networks, the Internet, an Intranet, satellite networks, or the like. Accordingly, the network 322 can be utilized as a wireless access point by the computer 324 to access one or more servers (e.g., a server 320). The server 320 and any additional servers generally include processors, memory, and chipset for delivering resources via the network 322. Resources can include providing, for example, processing, storage, software, and information from the server 320 to the system 300 via the network 322. Additionally, it is noted that the server 320 and any additional servers can share resources with one another over the network 322 such as, for example, via the wired portion of the network, the wireless portion of the network, or combinations thereof.

The tools described herein may be focused on a specific industry, such as manufacturing or quick service restaurants, to permit a majority of the key performance indicators to be standardized in the tool. Such standardization allows for ease of user accessibility and a reduced end-to-end solution time frame in which a user may access reports from user underlying data sources. However, the tools still provide for customization of reporting and key performance indicators creation in an efficient manner that provides for real-time reporting once the desired target tables are build and accessed by the user.

The tools described herein thus consolidate multi-site data with ease while enabling secure automatic data aggregation for multi-site systems using features of the tools. Further, the tools promote multi-vendor ERP connectivity and consolidation. The tools integrate data from multiple vendor ERP systems into a customizable industry standard, such as a manufacturing analytics platform for mid-size manufacturers having a majority of the same desired key performance indicators that may be built into the dashboards prior to mapping a vendor's ERP system into the tool for real-time reporting and efficient processing of vendor ERP data after completion of the mapping process of vendor data in a significantly reduced timeframe of less than a month and potentially a few days.

Further, the tools described herein provide one or more reports that are able to adapt in real-time and simultaneously to different currencies allowing for a multi-currency reporting solution and that are able to report across multiple geographies to enable comparisons and consolidate and optimize real-time reporting. The tools may provide one or more reports that present a global map overview, from which a user may click on certain geographies of the global map to filter and drill down into the reported details for a selected geographical area. Further, while the tool may default into themes and chart type structures, a user may in real-time change the type of chart structure for an analyzed report. For example, a user may select a button on or linked to the first chart 202 described above to change the bar chart of the first chart 202 into a pie chart, a line chart, or other desired chart type.

The system tools described herein effectively improves upon both the technology and technical area of data integration and KPI analysis and management by providing ready-to-use analytics including a quick and efficient time-to-value model, an ability to integrate multiple data sources in a streamlined fashion, an ability to customize metrics and reporting while still maintaining an efficiency in standard reporting, a simplified implementation for a vendor resulting in speedier implementation (i.e., of days, that sum to less than a week or month, rather than months for implementation) and a reduced cost structure of implementation and data management and platform servicing, and an optimized platform providing an end-to-end solution in a centralized architecture that is able to integrate a variety of source data from multiple sources (including cloud-based structures) for an industry-specific reporting structure and data management and integration system for big data analytics and reporting.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of extraction, transformation, and loading of source data into an integrated extract-transform-load (ETL) data warehouse analytical platform, the method comprising:
receiving a user selection on a graphical user interface (GUI) of one of a standard package option and a custom package option;
mapping source data from at least one data source column as mapped source data to at least one Input Layout (IL) column of a selected IL table of a plurality of pre-defined IL tables associated with a Data Layout (DL) table associated with a named standard package when the standard package option is selected;
mapping source data as mapped source data to a custom target table associated with a named custom package when the custom package option is selected;
populating the mapped source data with respect to at least one of the DL table and the custom target table, wherein each of the DL table and the custom target table include a plurality of columns respectively defined as one of a dimension and a measure;
eliminating source data that is not mapped to the at least one IL column or the at least one column of the custom target table when populating the mapped source data; and
displaying on the GUI at least one of a graphical and tabular report based on one or more key performance indicators (KPIs) associated with at least one of the DL table and the custom target table in real-time.

2. The method of claim 1, wherein the source data is from at least one of a flat file and a database query.

3. The method of claim 1, wherein a plurality of DL tables are associated with the named standard package.

4. The method of claim 1, wherein the dimension is indicative of categorical data.

5. The method of claim 1, wherein the measure is indicative of numerical data.

6. The method of claim 1, wherein a text field is defined as the dimension.

7. The method of claim 1, further comprising selecting by a user through the GUI an option to define an integer field as one of the dimension and the measure.

8. The method of claim 1, wherein populating the mapped source data comprises one of scheduling a time to populate to the mapped source data and selecting a run now option to populate the data.

9. The method of claim 1, further comprising validating the mapped source data prior to populating the mapped source data.

10. The method of claim 1, further comprising:
opening upon a dashboard developer application to select at least one of the DL table and the custom target table as a data set from which to display the at least one of a graphical and tabular report; and
receiving a user selection on the GUI of at least one dimension and at least one measure from the data set to display as the at least one of a graphical and tabular report, wherein the one or more KPIs are based on the at least one dimension and the at least one measured selected.

11. A system for extraction, transformation, and loading of source data into an integrated extract-transform-load (ETL) data warehouse analytical platform, the system comprising:
one or more processors;
one or more memory modules communicatively coupled to the one or more processors;
a graphical user interface (GUI); and
machine readable instructions stored in the one or more memory modules that cause the system to perform at least the following when executed by the one or more processors:
receive a user selection on the GUI of one of a standard package option and a custom package option;
map source data from at least one data source column as mapped source data to at least one Input Layout (IL) column of a selected IL table of a plurality of pre-defined IL tables associated with a Data Layout (DL) table associated with a named standard package when the standard package option is selected;
map source data as mapped source data to a custom target table associated with a named custom package when the custom package option is selected;
populate by the one or more processors the mapped source data with respect to at least one of the DL table and the custom target table, wherein each of the DL table and the custom target table include a plurality of columns respectively defined as one of a dimension and a measure;
eliminate by the one or more processors source data that is not mapped to the at least one IL column or the at least one column of the custom target table when populating the mapped source data; and
display on the GUI at least one of a graphical and tabular report based on one or more key performance indicators (KPIs) associated with at least one of the DL table and the custom target table in real-time.

12. The system of claim 11, wherein the source data is from at least one of a flat file and a database query.

13. The system of claim 11, wherein a plurality of DL tables are associated with the named standard package.

14. The system of claim 11, wherein the dimension is indicative of categorical data, and the measure is indicative of numerical data.

15. The system of claim 11, wherein a text field is defined as the dimension.

16. The system of claim 11, wherein the machine readable instructions further comprise instructions to select by a user through the GUI an option to define an integer field as one of the dimension and the measure.

17. The system of claim 11, wherein instructions to populate the mapped source data comprises instructions to one of schedule a time to populate to the mapped source data and receive a selection by a user on the GUI a run now option to populate the data.

18. The system of claim 11, wherein the machine readable instructions further comprise instructions to validate the mapped source data prior to population of the mapped source data.

19. The system of claim 11, wherein the machine readable instructions further comprise instructions to:
receive a selection on the GUI of at least one of the DL table and the custom target table as a data set from which to display the at least one of a graphical and tabular report; and
receive a user selection on the GUI of at least one dimension and at least one measure from the data set to display as the at least one of a graphical and tabular report, wherein the one or more KPIs are based on the at least one dimension and the at least one measured selected.

20. A method of extraction, transformation, and loading of source data into an integrated extract-transform-load (ETL) data warehouse analytical platform, the method comprising:
receiving a user selection on a graphical user interface (GUI) of one of a standard package option and a custom package option;
mapping source data from at least one data source column as mapped source data to at least one Input Layout (IL) column of a selected IL table of a plurality of IL tables associated with a Data Layout (DL) table associated with a named standard package when the standard package option is selected;
mapping source data as mapped source data to a custom target table associated with a named custom package when the custom package option is selected;
populating the mapped source data with respect to at least one of the DL table and the custom target table, wherein each of the DL table and the custom target table include a plurality of columns respectively defined as one of a dimension and a measure; and
opening upon a dashboard developer application to select on a GUI of the dashboard developer application at least one of the DL table and the custom target table as a data set from which to display at least one of a graphical and tabular report;
receiving a user selection on the GUI of the dashboard developer application of at least one dimension and at least one measure from the data set to display as the at least one of a graphical and tabular report; and
displaying in real-time on the GUI of the dashboard developer application the at least one of a graphical and tabular report based on the at least one dimension and the at least one measure representative of one or more key performance indicators (KPIs) associated with at least one of the DL table and the custom target table.
